(19) United States
(12) Patent Application Publication
(10) Pub. No.: US 2026/0237094 A1
(43) Pub. Date: Aug. 13, 2026

(54) CAMERA POSE ESTIMATION AND GUIDANCE FOR PATIENT IMAGES

(71) Applicant: Align Technology, Inc., San Jose, CA (US)

(72) Inventors: Chad Clayton Brown, Cary, NC (US); Guotu Li, Apex, NC (US); Christopher E. Cramer, Durham, NC (US); Adam Sill, Raleigh, NC (US); Phillip Thomas Harris, Cary, NC (US)

(21) Appl. No.: 19/537,141

(22) Filed: Feb. 11, 2026

Related U.S. Application Data
(60) Provisional application No. 63/757,619, filed on Feb. 12, 2025.
(60) Provisional application No. 63/767,833, filed on Mar. 6, 2025.

(51) Int. Cl. G06T 7/73

(52) U.S. Cl. CPC G06T 7/73; G06T 7/74; G06T 2207/30036

(57) ABSTRACT

Systems and methods for determining camera pose for a patient image are provided. A system can include one or more processors and a memory operably coupled to the one or more processors and storing instructions that, when executed by the one or more processors, cause the system to perform operations including receiving a 2D image including a depiction of teeth of at least one jaw of a patient, identifying a set of tooth landmarks representing geometries and locations of the teeth in the 2D image, where the set of tooth landmarks may be identified by inputting the 2D image into a first machine learning model, and determining a camera pose representing an estimated spatial relationship between the imaging device and the at least one jaw, where the camera pose is determined by inputting the identified set of tooth landmarks into a second machine learning model.

### CROSS-REFERENCE TO RELATED APPLICATION(S)

The present application claims the benefit of priority to U.S. Provisional Application No. 63/757,619, filed Feb. 12, 2025, and U.S. Provisional Application No. 63/767,833, filed Mar. 6, 2025, the disclosures of which are incorporated by reference herein in their entirety.

### TECHNICAL FIELD

The present technology generally relates to dentistry, and in particular, to camera pose estimation and guidance for patient images.

### BACKGROUND

Telemedicine systems can improve the convenience and accessibility of dental treatment by allowing clinicians to monitor the condition of a patient's teeth remotely. For instance, a clinician may evaluate the teeth and make treatment decisions based on photographs of the teeth, rather than requiring an in-person appointment to visually examine the teeth. However, the reliability and quality of remote dental treatment may be compromised if features of interest cannot be accurately and consistently understood from patient-provided photographs. Accordingly, it may be desirable to guide the patient to take images that are useful for monitoring and/or diagnostic purposes. However, conventional techniques for guiding the patient during photo taking lack the ability to rapidly and accurately determine how the camera and/or the patient's jaws should be adjusted.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIGS. 1A and 1B are partially schematic illustrations of guidance that may be provided to a patient during imaging, in accordance with embodiments of the present technology.

FIG. 2 is a block diagram providing a representative example of a workflow for determining camera pose for a patient image, in accordance with embodiments of the present technology.

FIG. 3 is a flow diagram illustrating a method for determining camera pose for a patient image, in accordance with embodiments of the present technology.

FIG. 4A is a block diagram providing a representative example of a workflow for determining camera pose for a patient image, in accordance with embodiments of the present technology.

FIG. 4B is a block diagram providing a representative example of a workflow for training the machine learning model of FIG. 4A via supervised learning, in accordance with embodiments of the present technology.

FIG. 5 is a flow diagram illustrating a method for determining camera pose for a patient image, in accordance with embodiments of the present technology.

FIG. 6A is a block diagram providing a representative example of a workflow for determining camera pose for a patient image, in accordance with embodiments of the present technology.

FIG. 6B is a block diagram providing a representative example of a workflow for training the first machine learning model of FIG. 6A via supervised learning, in accordance with embodiments of the present technology.

FIG. 6C is a block diagram providing a representative example of a workflow for training the second machine learning model of FIG. 6A via supervised learning, in accordance with embodiments of the present technology.

FIG. 7 is a flow diagram illustrating a method for determining camera pose for a patient image, in accordance with embodiments of the present technology.

FIG. 8 is a flow diagram illustrating a method for evaluating an acceptability of a patient image, in accordance with embodiments of the present technology.

FIG. 9A illustrates a representative example of a tooth repositioning appliance configured in accordance with embodiments of the present technology.

FIG. 9B illustrates a tooth repositioning system including a plurality of appliances, in accordance with embodiments of the present technology.

FIG. 9C illustrates a method of orthodontic treatment using a plurality of appliances, in accordance with embodiments of the present technology.

FIG. 10 illustrates a method for designing an orthodontic appliance, in accordance with embodiments of the present technology.

FIG. 11 illustrates a method for digitally planning an orthodontic treatment and/or design or fabrication of an appliance, in accordance with embodiments of the present technology.

### DETAILED DESCRIPTION

The present technology relates to systems and methods for determining camera pose (e.g., position and/or orientation of an imaging device) for a patient image. In some embodiments, for example, a computer-implemented method for identifying teeth in a patient image includes receiving a series of two-dimensional (2D) images (e.g., photographs) including a depiction of teeth of at least one jaw of a patient. The series of 2D images can be obtained using an imaging device (e.g., a mobile phone). The computer-implemented method can further include determining whether a previous camera pose representing an estimated spatial relationship (e.g., relative position and/or orientation) between the imaging device and the at least one jaw at a first time should be updated. For instance, the determination can be based on whether a predetermined time interval has elapsed, whether the imaging device has moved significantly, and/or any other indication that the previous camera pose is significantly different from the current camera pose. The computer-implemented method can further include, in response to a determination that the previous camera pose should be updated, selecting a 2D image of the series of 2D images, accessing a three-dimensional (3D) model of the patient's teeth, registering the 3D model to the selected 2D image, and determining, based on the registration, an updated camera pose representing an estimated spatial relationship between the imaging device and the at least one jaw at a second time after the first time.

Alternatively, in some embodiments, a computer-implemented method includes receiving a 2D image including a depiction of teeth of at least one jaw of a patient, where the 2D image is obtained using an imaging device. The computer-implemented method can further include determining a camera pose representing an estimated spatial relationship between the imaging device and the at least one jaw. The camera pose can be determined by inputting the 2D image into a machine learning model (e.g., a convolutional neural network), where the machine learning model is trained on image data and corresponding camera pose data. In some embodiments, the image data for the training includes previous 2D images of patient teeth, and the corresponding camera pose data is derived from the previous 2D images by registering the 2D images to 3D models of teeth.

Alternatively, in some embodiments, a computer-implemented method includes receiving a 2D image including a depiction of teeth of at least one jaw of a patient, where the 2D image is obtained using an imaging device. The computer-implemented method can further include identifying a set of tooth landmarks representing geometries and locations of the teeth in the 2D image. For instance, the set of tooth landmarks may be a tooth segmentation mask and/or may be other anatomical references such as crown centers of the patient's teeth. The set of tooth landmarks may be identified by inputting the 2D image into a first machine learning model, where the first machine learning model is trained on image data and first tooth landmark data corresponding to the image data. The image data and the first tooth landmark data may be derived from previous patient data (e.g., previous 2D images of patient teeth) and/or synthetic data (e.g., 2D images of 3D models of teeth). The computer-implemented method can also include determining a camera pose representing an estimated spatial relationship between the imaging device and the at least one jaw, where the camera pose is determined by inputting the identified set of tooth landmarks into a second machine learning model. The second machine learning model can be trained on second tooth landmark data and camera pose data corresponding to the second tooth landmark data. The second tooth landmark data and the camera pose data may also be derived from previous patient data and/or synthetic data (e.g., tooth segmentation masks derived from previous 2D images of patient teeth and/or 2D images of 3D models of teeth).

The present technology can provide various advantages compared to conventional techniques for dental treatment and monitoring. For example, some conventional techniques require that the patient visit the clinic before, during, and after treatment with high frequency, which can be challenging due to the associated time and resources expended. By incorporating remote evaluation, e.g., monitoring progress using patient-provided photographs, costs may be reduced, and more frequent check-ins may be viable. Further, conventional techniques for guidance during patient photo taking suffer from imprecision. For instance, an imaging device may be equipped with motion sensors that can attempt to estimate camera pose based on movements of the imaging device. However, even the slightest of movements may greatly affect camera pose while being difficult to track in real-time. Further, motion sensors on an imaging device may not capture the patient's head pose, such as shifts in jaw position and/or relationships between the upper and lower jaws. Moreover, some techniques for guiding a patient during photo taking may be too slow to provide real-time feedback. For instance, a significant delay may occur between the moment an image is taken and when the image is processed, e.g., when camera pose is determined and guidance is provided.

The present technology can address these and other challenges by determining camera pose for a patient image and providing guidance based on the determined camera pose. For instance, some embodiments of the present technology utilize a 3D-to-2D registration pipeline which can generate data either from real patient images or from synthetic renderings. The registration pipeline may provide sufficiently accurate estimates of camera pose and/or jaw pose for a patient image. Further, lightweight machine learning models (e.g., deep learning models) can be designed to determine camera pose and/or jaw pose in real-time during the patient photo taking process. Moreover, real-time guidance can be provided based on the determined camera pose and/or jaw pose, thereby improving user experience while also enhancing the quality and usability of patient images for dental diagnosis and/or monitoring purposes.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

As used herein, the terms “vertical,” “lateral,” “upper,” “lower,” “left,” “right,” etc., can refer to relative directions or positions of features of the embodiments disclosed herein in view of the orientation shown in the Figures. For example, “upper” or “uppermost” can refer to a feature positioned closer to the top of a page than another feature. These terms, however, should be construed broadly to include embodiments having other orientations, such as inverted or inclined orientations where top/bottom, over/under, above/below, up/down, and left/right can be interchanged depending on the orientation.

The headings provided herein are for convenience only and do not interpret the scope or meaning of the claimed present technology. Embodiments under any one heading may be used in conjunction with embodiments under any other heading.

I. Camera Pose and/or Jaw Pose Determination

In dental treatment and monitoring, the utility of a patient image depends at least in part on its ability to convey relevant and accurate information regarding the patient's intraoral and/or extraoral anatomy. In traditional clinical settings, images of a patient may be obtained to supplement physical examination; such images are generally taken in accordance with standard views (e.g., lateral view, frontal view, etc., as used in dental photography). However, clinical imaging is generally performed by trained professionals using established imaging equipment. For a patient in a remote location (e.g., at home), capturing clinically relevant images can be a difficult task. For instance, the patient may position the camera too close to or too far away from the patient's face, the camera may capture the wrong side of the patient's face, the patient's jaw may be too open or not open enough, etc. In such situations, the patient images may not be useful and may require retaking, or the patient images may lead to misdiagnosis or inconclusive findings. Thus, it may be useful to guide a patient during the photo taking process, such that the resultant images are of sufficient quality and relevance for clinical purposes.

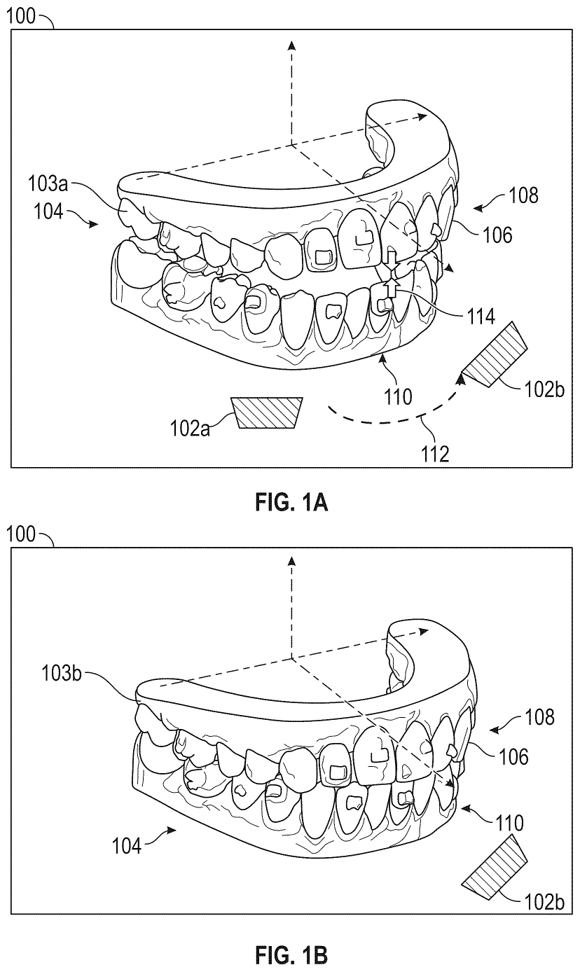

FIGS. 1A and 1B are partially schematic illustrations of guidance that may be provided to a patient during imaging of the patient's jaws with an imaging device, in accordance with embodiments of the present technology. Specifically, FIG. 1A illustrates a user interface 100 (“UI 100”) showing a current camera pose 102a of an imaging device and a current jaw pose 103a of the patient's jaws, and FIG. 1B illustrates the UI 100 showing a target camera pose 102b of the imaging device and a target jaw pose 103b of the patient's jaws.

Referring to FIGS. 1A and 1B together, a patient can obtain an image of one or both of the patient's jaws using an imaging device (e.g., a camera, such as a DSLR camera, a camera of a mobile device, etc.). The imaging device can be positioned at a particular position and/or orientation relative to the jaws (“camera pose”), and the jaws may be positioned at a particular position and/or orientation relative to each other (“jaw pose”). To obtain a clinically relevant image for monitoring and/or diagnostic purposes, it may be desirable for an image to be taken of a particular dental view. These particular dental views for clinically relevant images may be a set of prescribed views that generally applies to patients, such as an anterior view, right buccal view, left buccal view, maxillary occlusal view, mandibular occlusal view, etc. Additionally or alternatively, the particular dental views for a patient may be optimized for the patient based on the patient's specific dentition and/or treatment plan. For example, for a treatment stage that is intended to move a particular tooth in a particular direction, one clinically relevant image may be a view that is perpendicular to the particular direction so as to best show an amount of movement. The determining and capturing of clinically relevant images/views is discussed further in U.S. Pat. No. 11,991,440, which is incorporated by reference herein in its entirety. Further, it may be desirable for the patient to maintain a particular degree of jaw openness, e.g., open bite or closed bite.

However, in some situations, the patient may position the imaging device at an incorrect or suboptimal camera pose, and/or the patient's jaws may be in an incorrect or suboptimal jaw pose. For example, as shown in FIG. 1A, in the current camera pose 102a, the imaging device is positioned below and to the right (from the patient's perspective) of the patient's lower jaw. In this position, an image captured by the imaging device may prominently show a right buccal portion 104 of the patient's teeth 106. However, the image may fail to properly show other portions of the patient's teeth 106, such as a left buccal portion 108 or an anterior portion 110 of the patient's teeth 106. Additionally or alternatively, the portions that are captured may not be visible at an optimal angle for the particular dental view that is being targeted. For instance, in its current camera pose 102a, the imaging device may capture an image where the left buccal portion 108 of the teeth 106 are blocked by the right buccal portion 104 of the teeth 106. Further, the image may not clearly show the anterior portion 110 of the patient's teeth 106, e.g., the patient's anterior teeth may be obstructed or appear as distorted. This can be problematic, for example, in instances where the clinician is interested in monitoring and/or diagnosing the patient's anterior teeth, such as for evaluating the location of the dental midline. Additionally, in the current jaw pose 103a, the patient's jaws are in an open bite configuration, whereas the clinician may want the jaws to be in a closed bite configuration in this particular dental view (e.g., for evaluating malocclusion).

The systems and methods described herein can be configured to determine the current camera pose 102a of the imaging device and/or the current jaw pose 103a of the jaws, and to provide guidance to the patient to reposition the imaging device and/or jaws toward a target camera pose 102b (e.g., as represented by arrow 112 in FIG. 1A) and/or toward a target jaw pose 103b (e.g., as represented by arrows 114 in FIG. 1A) so that the obtained image depicts the desired view of the teeth 106. For example, as shown in FIG. 1B, in the target camera pose 102b, the imaging device is repositioned in front of the anterior portion 110 of the patient's teeth 106 of the jaws. In the target jaw pose 103b, the jaws 100 are in a closed bite configuration. In this position, an image captured by the imaging device may prominently and clearly show the anterior portion 110 of the patient's teeth 106. As noted above, this view may be beneficial in instances where the clinician is interested in monitoring and/or diagnosing conditions of the patient's anterior teeth.

The camera poses, jaw poses, and UI guidance illustrated in FIGS. 1A and 1B are examples only. In other embodiments, the imaging device can be guided and adjusted to many different views for a variety of clinical purposes, e.g., the imaging device may be guided to a superior or inferior position, the patient's jaws may be guided to increase a degree of openness for capturing an occlusal portion of the patient's teeth 106, other types of guidance besides arrows 112, 114 may be provided, etc.

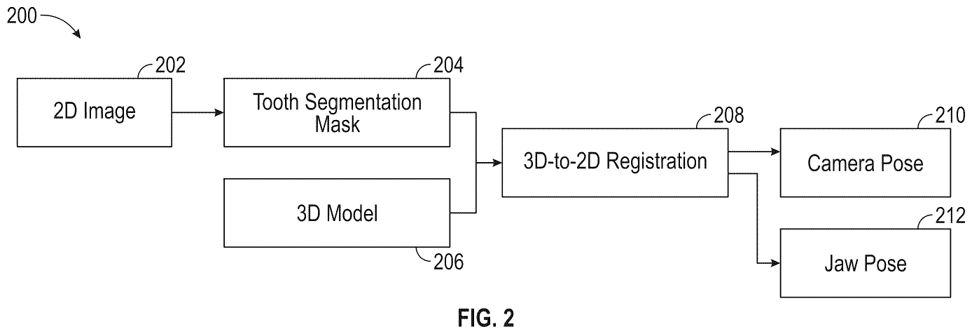

FIG. 2 is a block diagram illustrating a representative example of a workflow 200 for determining camera pose for a patient image, in accordance with embodiments of the present technology. In some embodiments, some or all of the processes described with respect to the workflow 200 are implemented as computer-readable instructions (e.g., program code) that are configured to be executed by one or more processors of a computing device (e.g., a mobile device, laptop, personal computer, workstation, remote server). The computing device may be part of a virtual dental care system as described in, e.g., U.S. Patent Application Publication No. 2022/0023003, the disclosure of which is incorporated by reference herein in its entirety. The workflow 200 can be utilized and/or combined with any of the methods described herein.

The workflow 200 can include receiving at least one 2D image 202 including a depiction of teeth of at least one jaw of a patient. The 2D image 202 can include any suitable image data type, such as one or more photographs, one or more frames of a video, etc., and may be a color image, a grayscale image, etc. The 2D image 202 can be received from any suitable imaging device, such as a camera. The imaging device can be a standalone device (e.g., DSLR camera, a mirrorless camera) or can be integrated into another device (e.g., the camera of a mobile device such as a smartphone or tablet). The imaging device may be operated by or associated with the patient, a healthcare provider (e.g., a clinician), or other suitable user.

In some embodiments, the 2D image 202 is obtained using the imaging device only, without assistance from any auxiliary devices. In other embodiments, however, the 2D image 202 can be obtained using the imaging device in combination with an auxiliary device to position the imaging device in a fixed spatial location with respect to the patient's teeth and/or to retract the patient's cheeks and lips to improve visibility of the teeth. For example, the auxiliary device can include one or more cheek retractors. As another example, the auxiliary device can be a tube-type device including a smartphone interface configured to couple to a smartphone (or other mobile device with a camera), a patient interface configured to retract the patient's cheeks and lips, and a tubular body between the smartphone interface and the patient interface with a lumen extending therethrough, e.g., as described in U.S. Patent Application Publication No. 2022/0338723, the disclosure of which is incorporated by reference herein in its entirety. Other representative examples of systems, methods, and devices for obtaining 2D images of a patient are provided in U.S. Patent Application Publication No. 2022/0023003, the disclosure of which is incorporated by reference herein in its entirety.

The 2D image 202 may depict the patient's mouth region, including the visible portions of the teeth and gingiva, as well as the patient's lips. However, the 2D image 202 may also depict other parts of the patient's anatomy, such as other facial features (e.g., eyes, eyebrows, nose, subnasion, cheeks, chin, jawline), head, neck, shoulders, and/or torso, or the entire body of the patient. The 2D image 202 can depict a single jaw of the patient (e.g., the upper jaw only or the lower jaw only) or may depict both jaws.

The 2D image 202 can be taken from a variety of camera poses, and the patient can assume a variety of facial expressions. For instance, the 2D image 202 can depict a profile view of the patient's head, a front view of the patient's head with a neutral expression, a front view of the patient's head while smiling, a view of the upper jaw, a view of the lower jaw, a right buccal view with the jaw closed, an anterior view with the jaw closed, a left buccal view with the jaw closed, a right buccal view with the jaw open, an anterior view with the jaw open, a left buccal view with the jaw open, and/or an occlusal view. The relevant view for the 2D image 202 may be determined based on the use case for the 2D image 202, e.g., an anterior closed bite view may be beneficial for evaluating symmetry of the patient's smile, an occlusal view may be beneficial for evaluating arch width, etc.

Further, the 2D image 202 may be captured as part of a series of images. For instance, the 2D image 202 can be a single frame of a video captured by an imaging device. The video may capture a real-time feed of the patient as the patient performs various motions and/or assumes various expressions as desired. For instance, the video may show the patient smiling, speaking, moving their jaws, turning their head, etc. The 2D image 202 may represent a particular frame of the video, e.g., capturing the patient mid-motion.

In some embodiments, the imaging device is part of or is operably coupled to a mobile device (e.g., smartphone, tablet), which can be operated by the patient, by a healthcare provider (e.g., a clinician), or other suitable user. The mobile device can implement a mobile application that instructs the user to capture image data. The image data can be processed locally, e.g., via one or more processors of the mobile device, the image data may be transmitted to a remote server or computer for processing, or suitable combinations thereof (e.g., some processing may be performed locally and some processing may be performed remotely).

The workflow 200 can further include generating a tooth segmentation mask 204 based on the 2D image 202. The tooth segmentation mask 204 can be an image or other data format including a plurality of regions corresponding to teeth and/or other anatomy depicted in the 2D image 202. For instance, the tooth segmentation mask 204 may include a plurality of regions corresponding to individual teeth (“tooth masks”). The tooth segmentation mask 204 may include a contour representing tooth boundaries for the individual teeth. Alternatively or in combination, the tooth segmentation mask 204 can include areas representing tooth geometries for each tooth, such as the regions enclosed by the contour. In some embodiments, the tooth segmentation mask 204 further includes or is associated with one or more tooth identifiers (e.g., the tooth identifiers may be embedded in the tooth segmentation mask 204 (e.g., as pixel values in an image representing the tooth segmentation mask 204, where particular pixel values are defined to correspond to particular teeth) or may be metadata that is provided together with the tooth segmentation mask 204). The tooth identifiers can be numbers (e.g., 1, 2, 3, etc.), symbols (e.g., +, −, *, etc.), descriptors (e.g., “canine,” “molar,” “incisor,” etc.), colors (e.g., red, green, blue, etc.), patterns (e.g., striped, dotted, etc.), and/or any other suitable notations. Many notation systems can be used, such as the universal numbering system, Palmer notation, and/or the FDI World Dental Federation notation. In some embodiments, the tooth identifiers are automatically generated during generation of the tooth segmentation mask 204. Alternatively, the tooth identifiers may be generated based on regions and/or contours defined by the tooth segmentation mask 204. Further, the tooth segmentation mask 204 may include other types of dental landmarks, such as one or more of crown centers, central incisors, a jaw center, or a dental midline.

The tooth segmentation mask 204 can be generated by a segmentation algorithm, manual segmentation, and/or a combination thereof. For instance, tooth segmentation may be performed using a machine learning model (e.g., a neural network) that has been trained on segmented images of teeth. In some embodiments, the machine learning model uses semantic segmentation techniques, e.g., as described in U.S. Patent Application Publication Nos. 2022/0023003 and 2023/0225831, the disclosures of which are incorporated by reference herein in their entirety. Other types of segmentation techniques that may alternatively or additionally be used for the workflows and methods described herein include, for example, object segmentation, instance segmentation, and panoptic segmentation.

The workflow 200 can further include receiving a 3D model 206 of the patient's teeth. The 3D model 206 can depict the 3D geometry of the patient's teeth and/or any other dental features of interest (e.g., intraoral anatomy, dental appliances, etc.). In some embodiments, the 3D model 206 depicts the patient's teeth in a current tooth arrangement, e.g., a tooth arrangement at the same time or substantially the same time as when the 2D image 202 of the patient's teeth was obtained. In some embodiments, the 3D model 206 depicts the patient's teeth in a previous tooth arrangement, e.g., a tooth arrangement before the 2D image 202 of the patient's teeth was obtained. In some embodiments, the 3D model 206 depicts the patient's teeth in a tooth arrangement specified by a treatment plan for the patient's teeth. For instance, the 2D image 202 can be obtained during a treatment stage of the treatment plan, and the tooth arrangement depicted in the 3D model 206 is a tooth arrangement for the current treatment stage, a previous treatment stage, or a planned future treatment stage. The tooth arrangement can be an initial tooth arrangement corresponding to an initial treatment stage (e.g., before any dental appliances have been worn on the teeth), an intermediate tooth arrangement corresponding to an intermediate treatment stage (e.g., after one or more dental appliances have been worn on the teeth), or a target tooth arrangement corresponding to a final or post-treatment stage (e.g., after tooth repositioning is complete).

In some embodiments, the 3D model 206 is accessed from a database, such as a model repository, a treatment planning datastore, etc. The database can be part of a local computing system, such as a dental treatment system or a machine learning system. Optionally, the 3D model 206 may be stored on a mobile device, such as a smartphone. Alternatively or additionally, the 3D model 206 can be accessed over a network (e.g., from a remote server).

The 3D model 206 can be generated based on data of the patient's teeth, such as from photographs and/or videos (as captured on, e.g., a mobile computing device such as a smartphone, or another suitable device with a camera), scan data (e.g., intraoral and/or extraoral scans), magnetic resonance imaging (MRI) data, and/or radiographic data (e.g., standard x-ray data such as bitewing x-ray data, panoramic x-ray data, cephalometric x-ray data, computed tomography (CT) data, cone-beam computed tomography (CBCT) data, fluoroscopy data). In some embodiments, for example, the 3D model 206 of the tooth arrangement is based on scan data obtained using an intraoral scanner. The scanner can include a probe (e.g., a handheld probe) for optically capturing 3D structures (e.g., by confocal focusing of an array of light beams). Examples of scanners include, but are not limited to, the iTero® intraoral digital scanner manufactured by Align Technology, Inc. In some embodiments, the data of the patient's teeth is used to generate a first 3D model 206 depicting a current and/or pre-treatment arrangement of the teeth, and the first 3D model 206 is then used to generate one or more additional 3D models 206 depicting the teeth in one or more planned tooth arrangements of a dental treatment plan. The 3D model 206 may be any suitable digital representation that shows the 3D geometry of the teeth, such as a surface or mesh model, a solid model, a point cloud, a plurality of stacked 2D images, etc.

In some embodiments, the 3D model 206 can be generated prior to the capture of the 2D image 202. For instance, the 3D model 206 may be generated during a previous dental appointment, e.g., an initial appointment prior to starting dental treatment or a routine dental appointment. In other embodiments, the 3D model 206 can be generated after, at, or near the time of the capture of the 2D image 202 (e.g., the 3D model 206 being generated based on previously acquired data).

The workflow 200 can continue with a 3D-to-2D registration 208. The 3D-to-2D registration 208 can include registering the 3D model 206 to the 2D image 202. The 3D model 206 can be registered to the 2D image 202 to determine a spatial mapping between the 3D reference frame (e.g., 3D coordinate space) of the 3D model 206 and the 2D reference frame (e.g., 2D coordinate space) of the 2D image 202, and the spatial mapping can correlate to a camera pose 210, as discussed further below. The registration can be performed, for example, by matching one or more teeth in the 3D model 206 to one or more teeth in the 2D image 202, e.g., based on the tooth segmentation mask 204, tooth identifiers, edges, shapes, location, etc. Alternatively or in combination, the registration can involve projecting the 3D model 206 into the 2D reference frame, e.g., based on knowledge or estimates of the imaging parameters for the 2D image 202 and/or by projecting the 3D model 206 according to a plurality of different simulated imaging parameters and selecting the set of imaging parameters that produce the greatest similarity between the projected 3D model 206 and the 2D image 202. The imaging parameters may include camera parameters for the imaging device used to obtain the 2D image 202, such as extrinsic camera parameters (e.g., camera pose) and/or intrinsic camera parameters (e.g., focal length, aperture, optical axis, center of projection, or principal point of the imaging device). For instance, the 3D model 206 may be registered to the 2D image 202 by iteratively projecting the 3D model 206 onto the 2D image 202 and adjusting virtual camera parameters until the registration is satisfactory. A satisfactory registration may include a registration where a similarity between the projected 3D model 206 and the 2D image 202 does not substantially improve with further iterations. Additionally or alternatively, a satisfactory registration may include a registration that exceeds a predetermined threshold for similarity between the projected 3D model 206 and the 2D image 202. Any suitable 3D-to-2D registration algorithm can be used, for example, as described in U.S. Pat. Nos. 11,020,205 and 11,723,748, which are incorporated by reference herein in their entirety.

The workflow 200 can also include determining a camera pose 210 based on the 3D-to-2D registration 208. In some embodiments, the camera pose 210 is determined during the 3D-to-2D registration 208. For instance, the camera pose 210 may be the virtual camera parameters that render the registration satisfactory, e.g., as described above. That is, the camera pose 210 may be described by parameters of a virtual camera (corresponding to the imaging device that captured the 2D image 202) in a virtual space of the 3D model 206 that would render a virtual image identical or near-identical to the 2D image 202. The camera pose 210 can include a position and orientation of the virtual camera or imaging device with respect to the at least one jaw of the patient. The camera pose 210 may be defined with respect to the 3D reference frame of the 3D model 206, with respect to the 2D reference frame of the 2D image 202, or a combination thereof. In some embodiments, the camera pose 210 is defined in relative terms. For instance, the camera pose 210 may be defined by a difference in distance (e.g., in the X, Y, and/or Z directions) between the imaging device and the at least one jaw and/or may be defined by a difference in angle (e.g., in pitch, yaw, and/or roll) between the imaging device and the at least one jaw.

Optionally, in embodiments where the 2D image 202 depicts at least portions of both jaws of the patient, a jaw pose 212 can be determined. As discussed herein, the jaw pose 212 can include a position and orientation of the upper jaw with respect to the lower jaw. In some embodiments, the upper and lower jaws can be registered in a joint-jaw registration. Specifically, a joint-jaw registration algorithm can be used to determine estimates for camera parameters (e.g., the camera pose 210) as well as the jaw pose 212 between the upper and lower jaws, such that the projection of the patient's upper and lower jaws under the estimated camera parameters aligns closely with the depiction of the upper and lower jaws in the 2D image 202. For instance, where the 2D image 202 depicts the patient's upper and lower jaws in a bite-open configuration (e.g., the upper and lower jaws are separated), the joint-jaw registration algorithm can match the upper and lower jaws in the 3D model 206 to the upper and lower jaws in the 2D image 202, e.g., by adjusting the degree of separation between the jaws in the 3D model 206. Further, where the 2D image 202 depicts the patient's upper and lower jaws in a bite-closed configuration, the joint-jaw registration can estimate where the lower jaw would sit with respect to the upper jaw based on a lower jaw articulator model. The lower jaw articulator model may, for example, define the range of articulation of the lower jaw relative to the upper jaw. This may be useful, for example, in constraining the possible range of spatial relationships between the upper and lower jaws for the registration process. Representative examples of joint-jaw registration techniques that are applicable to the present technology are provided in U.S. patent application Ser. No. 18/898,623, the disclosure of which is incorporated by reference herein in its entirety.

Alternatively or in addition, the camera pose 210 can include a first camera pose representing an estimated spatial relationship between the imaging device and the upper jaw, and a second camera pose representing an estimated spatial relationship between the imaging device and the lower jaw, and the jaw pose 212 can be determined based on the first camera pose and the second camera pose.

In some embodiments, the methods herein involve obtaining multiple 2D images of a patient (e.g., a series of image frames of a video), but the camera pose and/or jaw pose are not determined for all of the 2D images, but are instead determined only for certain 2D images. This approach may be advantageous to improve computational efficiency and/or to allow for real-time or near-real-time feedback on camera pose and/or jaw pose, such as in situations where the pose determination involves algorithms that are more computationally intensive (e.g., 3D-to-2D registration).

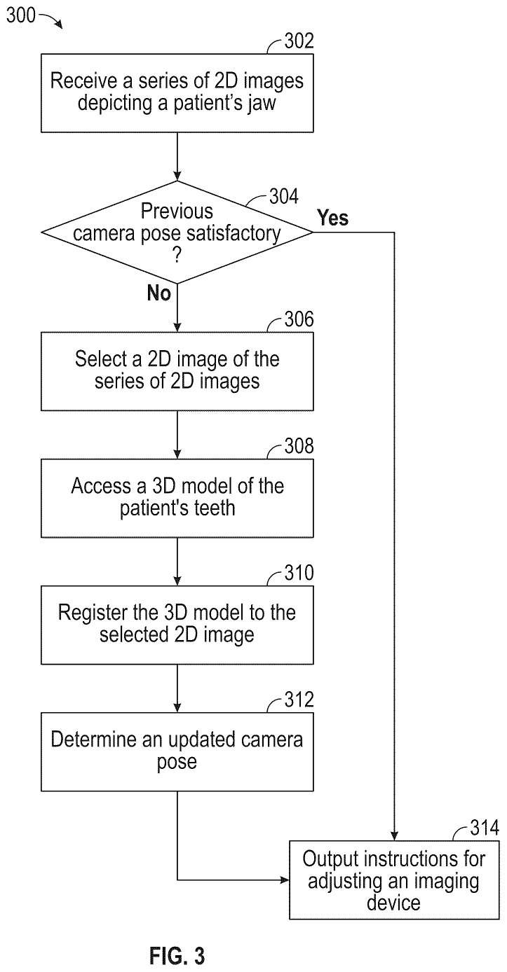

FIG. 3 is a flow diagram illustrating a method 300 for determining camera pose for a patient image, in accordance with embodiments of the present technology. In some embodiments, some or all of the processes described with respect to the method 300 are implemented as computer-readable instructions (e.g., program code) that are configured to be executed by one or more processors of a computing device (e.g., a mobile device, laptop, personal computer, workstation, remote server). The computing device may be part of a virtual dental care system as described in, e.g., U.S. Patent Application Publication No. 2022/0023003, the disclosure of which is incorporated by reference herein in its entirety. The method 300 can be used and/or combined with any of the methods described herein, e.g., the method 300 may be performed in combination with the workflow 200 of FIG. 2.

The method 300 can begin at block 302 with receiving a series of 2D images comprising a depiction of teeth of at least one jaw of a patient. The series of 2D images can include one or more 2D images that are similar to, e.g., the 2D image 202 of the workflow 200 of FIG. 2. For instance, the 2D images can include any suitable image data type, such as one or more photographs, one or more frames of a video, etc., and may be a color image, a grayscale image, etc. The 2D images can be received from any suitable imaging device, such as a camera of a mobile device. Optionally, the 2D images may be obtained using the imaging device in combination with an auxiliary device to position the imaging device in a fixed spatial location with respect to the patient's teeth and/or to retract the patient's cheeks and lips to improve visibility of teeth. In some embodiments, the 2D images may depict the patient's mouth region, including the visible portions of the teeth and gingiva, as well as the patient's lips. However, the 2D images may also depict other parts of the patient's anatomy, such as other facial features (e.g., eyes, eyebrows, nose, subnasion, cheeks, chin, jawline), head, neck, shoulders, and/or torso, or the entire body of the patient.

The 2D images can be taken from a variety of camera poses, and the patient can assume a variety of facial expressions. For instance, the 2D images can depict a profile view of the patient's head, a front view of the patient's head with a neutral expression, a front view of the patient's head while smiling, a view of the upper jaw, a view of the lower jaw, a right buccal view with the jaw closed, an anterior view with the jaw closed, a left buccal view with the jaw closed, a right buccal view with the jaw open, an anterior view with jaw open, a left buccal view with the jaw open, and/or an occlusal view. The relevant view for the 2D image may be determined based on the use case for the 2D image, e.g., an anterior closed bite view may be beneficial for evaluating symmetry of the patient's smile, an occlusal view may be beneficial for evaluating symmetry of the patient's smile, an occlusal view may be beneficial for evaluating arch width, etc. In some embodiments, each of the series of 2D images is a single frame of a video captured by an imaging device. The video may capture a real-time feed of the patient as the patient performs various motions and/or assumes various expressions as desired. For instance, the video may show the patient smiling, speaking, moving their jaws, turning their head, etc. The 2D images may each represent a particular frame of the video, e.g., capturing the patient mid-motion.

In some embodiments, the imaging device is part of or is operably coupled to a mobile device (e.g., smartphone, tablet), which can be operated by the patient, by a healthcare provider (e.g., a clinician), or other suitable user. The mobile device can implement a mobile application that instructs the user to capture image data. The image data can be processed locally, e.g., via one or more processors of the mobile device, the image data may be transmitted to a remote server or computer for processing, or suitable combinations thereof (e.g., some processing may be performed locally and some processing may be performed remotely).

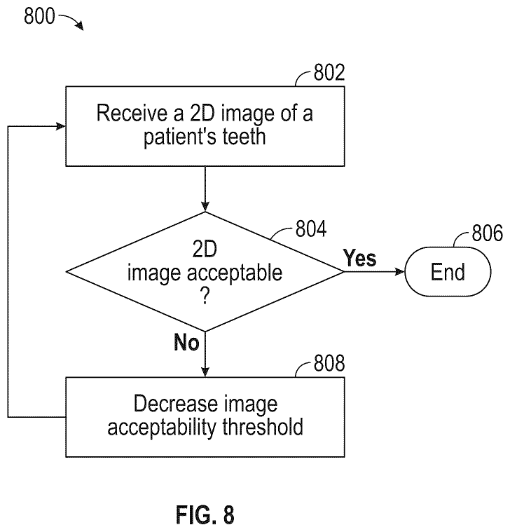

The method 300 can continue at block 304 with determining whether a previous camera pose representing an estimated spatial relationship between the imaging device and the at least one jaw at a first time is satisfactory, or whether the camera pose should be updated. In some embodiments, a camera pose is satisfactory when the camera pose can sufficiently capture a 2D image from a desired view (e.g., features of interest are shown and not obscured, the point of view matches the desired dental view). As described above with respect to FIGS. 1A and 1B, the camera pose may not always be satisfactory, e.g., the imaging device may be incorrectly positioned, and thus a 2D image taken with the imaging device may not adequately depict one or more features of interest (e.g., clinically relevant information). In some embodiments, determining whether the previous camera pose is satisfactory includes evaluating an acceptability of the 2D image, as will be described in connection with FIG. 8. For instance, a machine learning model can be used to determine whether the 2D image taken with the imaging device satisfies one or more acceptability parameters.

Additionally or alternatively, determining whether the previous camera pose should be updated includes determining whether a predetermined time interval has elapsed (e.g., if significant time has elapsed since the previous camera pose, there may be a higher likelihood that the patient and/or imaging device has moved significantly). For instance, an updated camera pose may be desirable when the time elapsed since the previous camera pose determination has exceeded 100 milliseconds, 250 milliseconds, 500 milliseconds, 1 second, 5 seconds, 10 seconds, 30 seconds, 1 minute, 2 minutes, 5 minutes, 10 minutes, etc. Alternatively or in combination, the determination may include determining whether a predetermined number of image frames have proceeded. For instance, the camera pose may need to be updated every 5 frames, every 10 frames, every 20 frames, every 50 frames, etc.

Alternatively or in combination, determining whether the previous camera pose should be updated can include determining whether an amount of movement/displacement of the imaging device exceeds a predetermined threshold. For instance, the amount of movement/displacement may be determined based on motion data received from a motion sensor coupled to the imaging device. The motion sensor may be an accelerometer, gyroscope, inertial sensor, etc. In some embodiments, the motion data is received continuously from the imaging device. Alternatively or in combination, the motion data may be received when the motion of the imaging device exceeds the predetermined threshold. Alternatively or in combination, the amount of movement/displacement may be determined based on the 2D images, e.g., using optical flow or other computer vision techniques to extrapolate motion/displacement from image data. The predetermined threshold may include a displacement (e.g., in the X, Y, and/or Z directions) of the imaging device of at least 1 mm, 5 mm, 1 cm, 5 cm, 10 cm, etc., and/or a rotation (e.g., in pitch, yaw, and/or roll) of the imaging device of at least 1 degree, 5 degrees, 10 degrees, 20 degrees, 30 degrees, 40 degrees, etc.

Alternatively or in combination, determining whether the previous camera pose should be updated can include accessing a set of registration parameters generated from registering the 3D model to a previously obtained 2D image. The set of registration parameters may correspond to the previous camera pose. The 3D model can be projected onto a 2D image of the series of 2D images (e.g., a different 2D image than the previously obtained 2D image) using the set of registration parameters. A deviation can be calculated between the projected 3D model and the 2D image. A deviation that exceeds a predetermined threshold may indicate that the registration is inaccurate (e.g., the current 2D image differs significantly from the previously obtained 2D image), and thus may indicate that the previous camera pose may need to be updated.

In response to a determination that the camera pose should be updated, the method 300 can continue at block 306 with selecting a 2D image of the series of 2D images. The selected 2D image may include a 2D image that corresponds to or is otherwise likely to represent the current camera pose. For instance, the selected 2D image may include a 2D image that was captured after a previous 2D image corresponding to the previous camera pose. For instance, the selected 2D image can be the most recently captured 2D image. Alternatively or in addition, the selected 2D image may include a 2D image that has a higher image quality than the previous 2D image. Alternatively or in addition, the selected 2D image may be selected from a subset of images that share similar image data, e.g., do not vary significantly from one another. Further, where motion data is measured by the imaging device, the 2D image may be selected based on the motion data. For instance, the selected 2D image may correspond to a 2D image taken during a time period where the imaging device had little to no motion.

Using the selected 2D image, the method 300 can continue with updating the camera pose based on the selected 2D image. The processes involved in updating the camera pose can be the same or generally similar as the camera pose estimation processes of the workflow 200 of FIG. 2. For instance, the method 300 can continue at block 308 with accessing a 3D model of the patient's teeth. The 3D model may depict the 3D geometry of the patient's teeth and/or any other dental features of interest (e.g., intraoral anatomy, dental appliances). The 3D model can be registered to the selected 2D image at block 310. In some embodiments, registering the 3D model to the selected 2D image includes iteratively projecting the 3D model onto the selected 2D image and adjusting virtual camera parameters until the registration is satisfactory (e.g., a sufficient degree of similarity between the projected 3D model and the selected 2D image has been reached). Optionally, the registration includes comparing the 3D model with a tooth segmentation mask associated with the selected 2D image and/or using information from the tooth segmentation mask (e.g., tooth identifiers) as input to the registration algorithm.

In some embodiments, the registration in block 310 uses information from previously performed registrations, such as a previous registration for a previous 2D image corresponding to the previous camera pose. For instance, the registration of the 3D model to the selected 2D image may use the previous registration parameters and/or previous camera pose as a starting point, which can increase the registration efficiency by decreasing the number of iterations needed. Alternatively or in combination, motion data (e.g., from a motion sensor coupled to the imaging device, such as an accelerometer, gyroscope, inertial sensor, etc.) can be used to extrapolate how the camera pose has changed since the previous camera pose, which in turn may be used as a starting point for the registration algorithm.

The method 300 can continue at block 312 with determining, based on the registration, an updated camera pose representing an estimated spatial relationship between the imaging device and the at least one jaw at a second time after the first time. The updated camera pose may be or include the virtual camera parameters that render the registration satisfactory. The updated camera pose may be defined with respect to the 3D reference frame of the 3D model, with respect to the 2D reference frame of the 2D image, or a combination thereof. In some embodiments, the camera pose is defined in relative terms. For instance, the camera pose may be defined by a difference in distance (e.g., in the X, Y, and/or Z directions) between the imaging device and the at least one jaw and/or may be defined by a difference in angle (e.g., in pitch, yaw, and/or roll) between the imaging device and the at least one jaw.

Optionally, the method 300 can continue at block 314 with outputting instructions for adjusting an imaging device, e.g., from the updated camera pose toward a target camera pose. In some embodiments, instead of outputting explicit instructions, the method 300 may simply output the location and/or orientation of a current camera pose, and/or output the location and/or orientation of a target camera pose. As described elsewhere herein, the target camera pose can be configured to produce a view of the patient that is clinically relevant for diagnostic and/or monitoring purposes. In some embodiments, the target camera pose is set by the clinician. For instance, the clinician may request a particular camera pose that is informative to the clinician with respect to the patient's treatment. Alternatively or in combination, the target camera pose may be automatically determined for the patient based on information associated with the patient and/or the treatment. For example, a set of target camera poses may be determined for the patient based on the tooth movements that are scheduled to occur at a current stage (e.g., to capture clinically relevant images as described herein). Alternatively or in combination, the target camera pose may be a standard camera pose that is used for a majority of or all patients. Alternatively or in combination, the target camera pose may be a camera pose that is determined based on a previous camera pose. For instance, a previous image captured using the previous camera pose may cover a first feature of interest, and the target camera pose may be automatically set to capture a second feature of interest different from the first feature of interest.

The process of block 314 can include comparing the updated camera pose to the target camera pose to determine whether there are significant deviations in position and/or orientation. If the deviations are significant (e.g., exceed a threshold translational and/or rotational distance), one or more adjustments to the imaging device can be determined to correct the camera pose. In some embodiments, the comparison can include determining a positional difference between the updated camera pose and the target camera pose. For instance, the updated camera pose may include a first camera position, the target camera pose may include a second camera position, and the comparison may include calculating a positional difference (e.g., in X, Y, and/or Z directions) between the first camera position and the second camera position. Alternatively or in combination, the comparison may include determining an angular difference (e.g., in pitch, yaw, and/or roll) between the updated camera pose and the target camera pose. For instance, the updated camera pose may include a first orientation, the target camera pose may include a second orientation, and the comparison may include calculating an angular difference between the first orientation and the second orientation.

In some embodiments, the instructions may be output on a display that is part of or operably coupled to the imaging device. The instructions may be audio instructions and/or visual instructions on a display device (e.g., images, video, icons, and/or text displayed on a screen of the imaging device). For instance, in embodiments where the imaging device is part of a mobile device (e.g., a smartphone camera), the instructions may be shown on a display of the mobile device. In some embodiments, the instructions include textual indicators (e.g., “tilt left”), graphical indicators (e.g., arrows, symbols, animations, dashes), audible indicators (e.g., speech, alerts, sounds), haptic feedback, animations or images showing how to move the imaging device to a target pose, and/or other indicators suitable for guiding the patient to adjust the camera pose. For instance, in some embodiments, a graphical indicator is displayed on the display. The graphical indicator may be a curved arrow indicating a translation and/or rotation of the imaging device, an alignment target (e.g., crosshairs, tooth outlines) that is overlaid on a real-time video feed of the patient's face, etc. More information about guidance and instructions for positioning a camera device is available in U.S. Pat. Nos. 10,595,966 and 10,779,718, the disclosures of which are incorporated by reference herein in their entirety.

The display can be associated with a computing device (e.g., a mobile device, personal computer, laptop, tablet, workstation). The computing device can be part of a computing system (e.g., a virtual dental care system) that includes one or more local client devices (e.g., patient devices and/or clinician devices) communicably coupled to a remote server (e.g., of a dental appliance manufacturer and/or a treatment monitoring service provider) via a communications network. In some embodiments, the computing device used to display the instructions is the same as the computing device used to perform the other processes of the method 300, e.g., all of the processes of the method 300 are performed by a local client device. In other embodiments, the computing device used to display the instructions is different than the computing device used to perform the other processes of the method 300, e.g., the instructions are displayed by a local client device (e.g., mobile phone) and the other processes are performed by a remote server.

In some embodiments, the instructions may be configured to change in response to readjustment of the imaging device. For instance, as the imaging device is moved, the processes of blocks 306-312 can be repeated such that the instructions are updated continuously or substantially continuously (e.g., in real-time or near-real-time). In other embodiments, the instructions are updated only after a new image is captured.

Returning to block 304, in response to a determination that the previous camera pose is satisfactory, the method 300 can continue directly to block 314 to output instructions for adjusting the imaging device. This can occur, for instance, where an updated camera pose is not necessary for guiding the patient to a target camera pose, or where the captured image is already satisfactory for its intended purposes.

The method 300 illustrated in FIG. 3 can be modified in many different ways. For example, the ordering of the processes shown in FIG. 3 can be varied, some of the processes of the method 300 can be omitted, and/or the method 300 can include additional processes not shown in FIG. 1. For instance, the process of block 314 may be omitted from the method 300. Further, the method 300 may include performing one or more image processing operations on the received series of 2D images received in block 302 and/or the selected 2D image of block 306. The image processing operations may include one or more of de-noising, cleaning, segmentation, normalization, thresholding, filtering, downsampling, equalization, or augmentation techniques. Further, the method 300 may continue with capturing an updated 2D image following the adjustment instructions. The method 300 may determine a camera pose for the updated 2D image and return to block 304 with determining whether the determined camera pose for the updated 2D image is satisfactory.

Optionally, the method 300 can further include determining whether a previous jaw pose is satisfactory, determining an updated a jaw pose for the patient's jaws, and outputting instructions for adjusting the patient's jaws, if appropriate. These processes may be generally similar to the processes of blocks 302-314. For instance, the previous jaw pose can include a position and orientation of the upper jaw with respect to the lower jaw. The previous jaw pose may be deemed unsatisfactory, e.g., if significant time has elapsed and/or if there is other information indicating that the jaws may have moved significantly since the previous jaw pose was determined. An updated jaw pose can be determined based on a selected 2D image (which may or may not be the same as the 2D image used to determine the updated camera pose), e.g., using a joint-jaw registration as described elsewhere herein. The updated jaw pose can be compared to a target jaw pose to identify any deviations that may be present. If significant deviations are present, instructions can be output to the patient to guide them in moving their jaws toward the target jaw pose. The processes of jaw pose determination may be performed concurrently or sequentially with the processes of camera pose determination, and may or may not be performed at the same frequency as the camera pose determination.

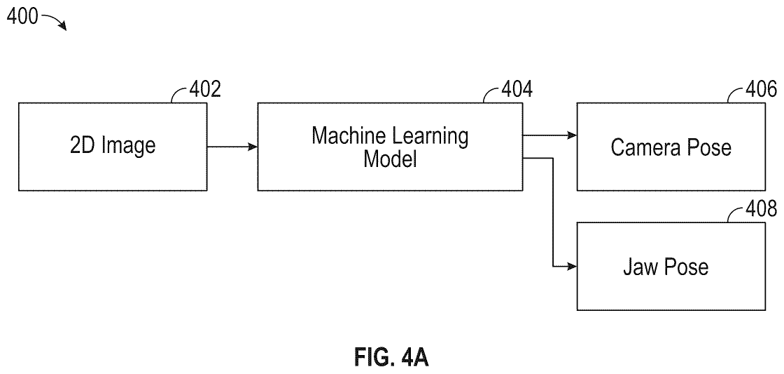

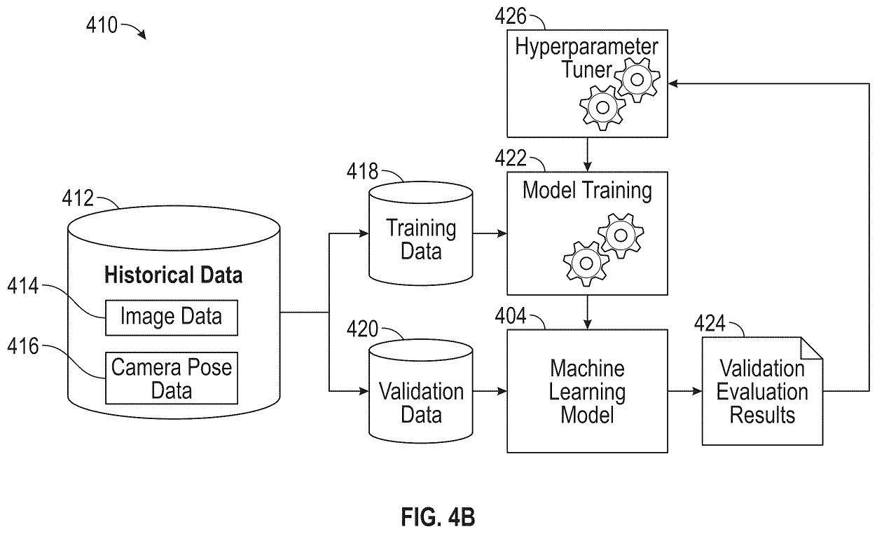

FIG. 4A is a block diagram providing a representative example of a workflow 400 for determining camera pose for a patient image, in accordance with embodiments of the present technology. In some embodiments, some or all of the processes described with respect to the workflow 400 are implemented as computer-readable instructions (e.g., program code) that are configured to be executed by one or more processors of a computing device (e.g., a mobile phone, laptop, personal computer, workstation, remote server). The computing device may be part of a virtual dental care system as described in, e.g., U.S. Patent Application Publication No. 2022/0023003, the disclosure of which is incorporated by reference herein in its entirety. The workflow 400 can be utilized and/or combined with any of the methods described herein.

The workflow 400 can include receiving at least one 2D image 402 depicting at least one jaw of the patient. The 2D image 402 can be generally similar to any of the 2D images described herein, such as the 2D image 202 of FIG. 2. For instance, the 2D image 402 can include any suitable image data type, such as one or more photographs, one or more frames of a video, etc., and may be a color image, a grayscale image, etc. The 2D image 402 can be received from any suitable imaging device, such as a camera of a mobile device. Optionally, the 2D image 402 may be obtained using the imaging device in combination with an auxiliary device to position the imaging device in a fixed spatial location with respect to the patient's teeth and/or to retract the patient's cheeks and lips to improve visibility of teeth.

In some embodiments, the 2D image 402 may depict the patient's mouth region, including the visible portions of the teeth and gingiva, as well as the patient's lips. However, the 2D image 402 may also depict other parts of the patient's anatomy, such as other facial features (e.g., eyes, eyebrows, nose, subnasion, cheeks, chin, jawline), head, neck, shoulders, and/or torso, or the entire body of the patient. The 2D image 402 can depict a profile view of the patient's head, a front view of the patient's head with a neutral expression, a front view of the patient's head while smiling, a view of the upper jaw, a view of the lower jaw, a right buccal view with the jaw closed, an anterior view with the jaw closed, a left buccal view with the jaw closed, a right buccal view with the jaw open, an anterior view with the jaw open, a left buccal view with the jaw open, and/or an occlusal view.

In some embodiments, the imaging device is part of or is operably coupled to a mobile device (e.g., smartphone, tablet), which can be operated by the patient, by a healthcare provider (e.g., a clinician), or other suitable user. The mobile device can implement a mobile application that instructs the user to capture image data. The image data can be processed locally, e.g., via one or more processors of the mobile device, the image data may be transmitted to a remote server or computer for processing, or suitable combinations thereof (e.g., some processing may be performed locally and some processing may be performed remotely).

The workflow 400 can further include inputting the 2D image 402 into a machine learning model 404 to determine a camera pose 406 representing an estimated spatial relationship between the imaging device and the at least one jaw in the 2D image 402. In some embodiments, the machine learning model 404 is a trained machine learning model that can determine camera poses directly from 2D images, e.g., without requiring 3D models of the patient's teeth and/or requiring a 3D-to-2D registration process. The input data to the machine learning model 404 may include only the 2D image 402, or may include other types of data (e.g., image metadata including intrinsic camera parameters (e.g., focal length, aperture, optical axis, center of projection, or principal point of the imaging device), motion data of the imaging device, a previous camera pose of the imaging device).

The machine learning model 404 can utilize at least one machine learning algorithm, such as any of the following: a regression algorithm (e.g., ordinary least squares regression, linear regression, logistic regression, stepwise regression, multivariate adaptive regression splines, locally estimated scatterplot smoothing), an instance-based algorithm (e.g., k-nearest neighbor, learning vector quantization, self-organizing map, locally weighted learning), regularization algorithms (e.g., ridge regression, least absolute shrinkage and selection operator, elastic net, least-angle regression), a decision tree algorithm (e.g., Iterative Dichotomiser 3 (ID3), C4.5, C5.0, classification and regression trees, chi-squared automatic interaction detection, decision stump, M5), a Bayesian algorithm (e.g., naïve Bayes, Gaussian naïve Bayes, multinomial naïve Bayes, averaged one-dependence estimators, Bayesian belief networks, Bayesian networks, hidden Markov models, conditional random fields), a clustering algorithm (e.g., k-means, single-linkage clustering, k-medians, expectation maximization, hierarchical clustering, fuzzy clustering, density-based spatial clustering of applications with noise (DBSCAN), ordering points to identify cluster structure (OPTICS), non-negative matrix factorization (NMF), latent Dirichlet allocation (LDA), Gaussian mixture model (GMM)), an association rule learning algorithm (e.g., apriori algorithm, equivalent class transformation (Eclat) algorithm, frequent pattern (FP) growth), an artificial neural network algorithm (e.g., perceptrons, neural networks, back-propagation, Hopfield networks, autoencoders, Boltzmann machines, restricted Boltzmann machines, spiking neural nets, radial basis function networks), a deep learning algorithm (e.g., deep Boltzmann machines, deep belief networks, convolutional neural networks, stacked auto-encoders), a dimensionality reduction algorithm (e.g., PCA, independent component analysis (ICA), principle component regression (PCR), partial least squares regression (PLSR), Sammon mapping, multidimensional scaling, projection pursuit, linear discriminant analysis, mixture discriminant analysis, quadratic discriminant analysis, flexible discriminant analysis), an ensemble algorithm (e.g., boosting, bootstrapped aggregation, AdaBoost, blending, gradient boosting machines, gradient boosted regression trees, random forest), or suitable combinations thereof.

In some embodiments, the machine learning model 404 is or includes a convolutional neural network (CNN) that is trained to perform the determination. CNNs are a type of machine learning algorithm that can be used in the processing of images and/or other array-like data structures. A CNN is composed of a plurality of layers, with each layer including one or more neurons to which the operations described herein are applied. The CNN can transform input data (e.g., data received at an input layer) into output data (e.g., data output by an output layer) through a network architecture including a plurality of intermediate layers. In some embodiments, the plurality of intermediate layers includes one or more convolutional layers. Each convolutional layer of a CNN can apply at least one filter (also known as a “kernel”) to input data from a preceding layer via a convolutional operation. The parameters of the kernel (e.g., kernel size, weight, biases, parameters of the kernel function(s)) can be learned from training data (e.g., using backpropagation). The CNN can optionally include multiple convolutional layers, with the input data for each convolutional layer including output data from a preceding layer (e.g., another convolutional layer or another type of layer).

In some embodiments, the CNN includes one or more additional layers besides the one or more convolutional layers, such as at least one pooling layer and/or at least one fully connected layer. The at least one pooling layer can apply a spatial reduction operation to a preceding layer. In some embodiments, the at least one pooling layer performs dimensionality reduction. The at least one pooling layer can apply any variety of operations, such as max pooling, min pooling, average pooling, and global pooling. The at least one fully connected layer is connected to all preceding and succeeding layers. The at least one fully connected layer can apply a transformation to a preceding layer. In some embodiments, the at least one fully connected layer includes a linear transformation (e.g., affine functions). In some embodiments, the at least one fully connected layer includes a non-linear transformation (e.g., sigmoid, softmax, tanh, rectified linear unit functions). While the CNN has been discussed with respect to the plurality of layers, it should be understood that any of the layers can include one or more neurons at which operations are applied. Further, the CNN can include any arrangement of layers forming a customized network architecture. The determination produced by the CNN can include output data from a convolutional layer, pooling layer, fully connected layer, or any other layer of the CNN.

Although certain embodiments of the machine learning model 404 may use a CNN, in other embodiments, the machine learning model 404 can be or include a recurrent neural network (RNN), a generative adversarial network (GAN), a capsule network (CapsNet), a graph neural network (GNN), an autoencoder, a vision transformer (ViT), etc.

FIG. 4B is a block diagram providing a representative example of a workflow 410 for training the machine learning model 404 of FIG. 4A via supervised learning, in accordance with embodiments of the present technology. In some embodiments, the machine learning model 404 is trained using historical data 412 including image data 414 and camera pose data 416. The image data 414 can include a plurality of training images. The training images may include images that have been collected from previous patients and/or images that have been synthetically produced (e.g., 2D images generated from 3D models of teeth rather than actual patient images). The training images may include images taken from a variety of camera poses. For instance, the training images may differ in position and/or orientation of the imaging device used to capture the training images. In some embodiments, the training images include images captured from a frontal view, images captured from a buccal view, images captured from a posterior view, images captured from an occlusal view, etc.

In some embodiments, the image data 414 further includes segmentation data. For instance, the image data 414 can include a plurality of segmentation masks corresponding to the plurality of training images. The segmentation masks may be or include tooth segmentation masks, such as described above in connection with the tooth segmentation mask 204 of the workflow 200 of FIG. 2. For instance, tooth segmentation masks may be generated from the training images and can include regions (e.g., tooth masks) corresponding to individual teeth and/or contours representing tooth boundaries. Optionally, the tooth segmentation masks can include tooth identifiers identifying one or more of the patient's teeth. The tooth segmentation masks may be generated by a segmentation algorithm, manual segmentation, and/or a combination thereof.

The camera pose data 416 can include a corresponding training camera pose for each training image of the image data 414. In some embodiments, each training camera pose is determined for a respective training image by a process that may be identical or similar to the 3D-to-2D registration 208 of the workflow 200 of FIG. 2. For instance, determining the training camera pose can include accessing the training image, accessing a 3D model of teeth corresponding to the teeth of the training image, registering the 3D model to the training image (e.g., based on the segmentation data), and determining the training camera pose based on the registration. In some embodiments, registering the 3D model to the training image includes iteratively projecting the 3D model onto the training image and adjusting virtual camera parameters until the registration is satisfactory (e.g., a sufficient degree of similarity between the projected 3D model and the selected 2D image has been reached). As described above in connection with the 3D-to-2D registration 208 of the workflow 200 of FIG. 2, the training camera pose may include the virtual camera parameters that provided satisfactory registration of the 3D model to the training image.

The historical data 412 can be partitioned into training data 418 and validation data 420. The training data 418 can include annotated image data and camera pose data that are used in a model training process 422 to train the machine learning model 404. The model training process 422 may include learning associations between the annotated image data and the camera pose data of the training data 418. The validation data 420 can include annotated image data and camera pose data that are not used in the model training process 422. In some embodiments, the validation data 420 is used to retrain the machine learning model 404. For instance, the annotated image data of the validation data 420 can be input into the machine learning model 404, and the machine learning model 404 can generate predicted camera pose data based on the annotated image data of the validation data 420. The predicted camera pose data can be compared to the camera pose data of the validation data 420 to produce validation evaluation results 424. The validation evaluation results 424 can take any form, such as a loss (e.g., error) between the predicted camera pose data and the camera pose data of the validation data 420. Based on the loss, hyperparameters of the machine learning model 404 can be tuned via a hyperparameter tuner 426, and the model can be retrained until the validation evaluation results 424 are satisfactory. In some embodiments, the validation evaluation results 424 are satisfactory when the loss is below a predetermined error tolerance. The processes described above with respect to FIG. 4B are provided as examples; any number of additional or alternative training processes are possible.

Referring again to FIG. 4A, after the machine learning model 404 has been trained, the machine learning model 404 can be configured to determine camera poses from 2D images without accessing 3D models of teeth. In some embodiments, the output of the machine learning model 404 is used directly as the camera pose 406. In other embodiments, the output of the machine learning model 404 may be processed to determine the camera pose 406, e.g., intrinsic camera parameters such as focal length may be used to calculate the camera pose 406.

The workflow 400 can continue with outputting the camera pose 406. The camera pose 406 can include a position and orientation of the imaging device with respect to the at least one jaw of the patient. In some embodiments, the camera pose 406 may be defined with respect to a 2D reference frame of the 2D image 402. In some embodiments, the camera pose 406 is defined in relative terms. For instance, the camera pose 406 may be defined by a difference in distance (e.g., in the X, Y, and/or Z directions) between the imaging device and the at least one jaw and/or may be defined by a difference in angle (e.g., in pitch, yaw, and/or roll) between the imaging device and the at least one jaw.

Optionally, in embodiments where the 2D image 402 depicts both jaws of the patient, the workflow 400 can further include determining a jaw pose 408. The jaw pose 408 may be determined by the same machine learning model 404 used to determine the camera pose 406 or may be determined by a different machine learning model. In such embodiments, the machine learning model can be trained on image data and jaw pose data, e.g., similar to the training of the machine learning model 404 discussed above. Alternatively, the jaw pose 408 may be determined using other techniques, e.g., the camera pose 406 can include a first camera pose representing an estimated spatial relationship between the imaging device and the upper jaw, and a second camera pose representing an estimated spatial relationship between the imaging device and the lower jaw, and the jaw pose 408 can be determined based on the first camera pose and the second camera pose.

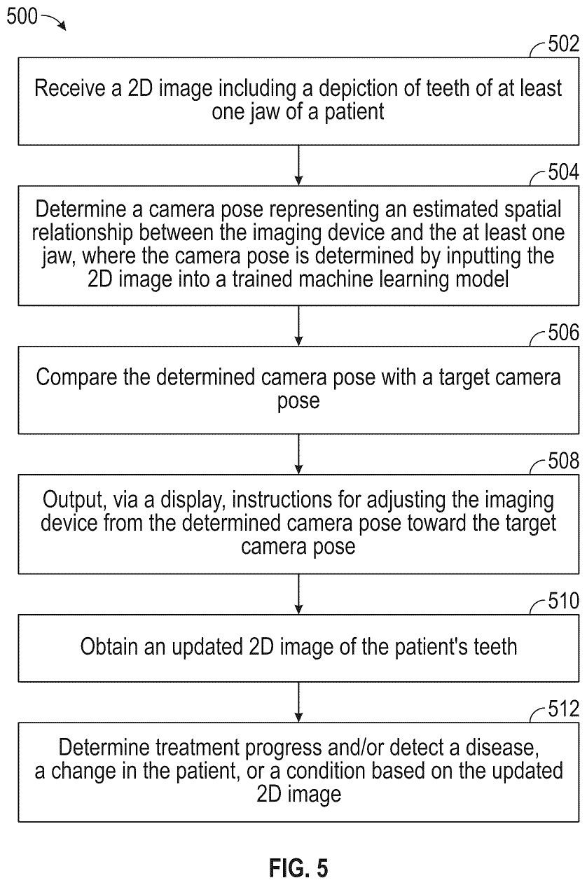

FIG. 5 is a flow diagram illustrating a method 500 for determining camera pose for a patient image, in accordance with embodiments of the present technology. In some embodiments, some or all of the processes described with respect to the method 500 are implemented as computer-readable instructions (e.g., program code) that are configured to be executed by one or more processors of a computing device (e.g., a mobile device, laptop, personal computer, workstation, remote server). The computing device may be part of a virtual dental care system as described in, e.g., U.S. Patent Application Publication No. 2022/0023003, the disclosure of which is incorporated by reference herein in its entirety. The method 500 can be used and/or combined with any of the methods described herein, e.g., the method 500 may be performed in combination with the workflow 400 of FIG. 5.

The method 500 can begin at block 502 with receiving a 2D image including a depiction of teeth of at least one jaw of a patient. The 2D image can be generally similar to any of the 2D images described herein, such as the 2D image 202 of the workflow 200 of FIG. 2 or the 2D image 402 of the workflow 400 of FIG. 4A. For instance, the 2D image can include any suitable image data type, such as one or more photographs, one or more frames of a video, etc., and may be a color image, a grayscale image, etc. The 2D image can be received from any suitable imaging device, such as a camera of a mobile device. Optionally, the 2D image may be obtained using the imaging device in combination with an auxiliary device to position the imaging device in a fixed spatial location with respect to the patient's teeth and/or to retract the patient's cheeks and lips to improve visibility of teeth. In some embodiments, the 2D image may depict the patient's mouth region, including the visible portions of the teeth and gingiva, as well as the patient's lips. However, the 2D image may also depict other parts of the patient's anatomy, such as other facial features (e.g., eyes, eyebrows, nose, subnasion, cheeks, chin, jawline), head, neck, shoulders, and/or torso, or the entire body of the patient.

The 2D image can be taken from a variety of camera poses, and the patient can assume a variety of facial expressions. For instance, the 2D image can depict a profile view of the patient's head, a front view of the patient's head with a neutral expression, a front view of the patient's head while smiling, a view of the upper jaw, a view of the lower jaw, a right buccal view with the jaw closed, an anterior view with the jaw closed, a left buccal view with the jaw closed, a right buccal view with the jaw open, an anterior view with the jaw open, a left buccal view with the jaw open, and/or an occlusal view. Further, the 2D image may be captured as part of a series of images, e.g., as described elsewhere herein.

In some embodiments, the imaging device is part of or is operably coupled to a mobile device (e.g., smartphone, tablet), which can be operated by the patient, by a healthcare provider (e.g., a clinician), or other suitable user. The mobile device can implement a mobile application that instructs the user to capture image data. The image data can be processed locally, e.g., via one or more processors of the mobile device, the image data may be transmitted to a remote server or computer for processing, or suitable combinations thereof (e.g., some processing may be performed locally and some processing may be performed remotely).

The method 500 can continue at block 502 with determining a camera pose representing an estimated spatial relationship between the imaging device and the at least one jaw. In some embodiments, the camera pose is determined by inputting the 2D image into a machine learning model that is trained to determine camera poses from 2D images. The machine learning model can be trained using image data and corresponding camera pose data, e.g., as previously discussed with respect to the workflow 400 of FIG. 4A. For instance, the image data may include a plurality of training images, and the camera pose data may include a corresponding training camera pose for each training image, where each training camera pose via a 3D-to-2D registration process. After the machine learning model has been trained using the image data and the camera pose data, the machine learning model can be configured to determine camera poses from 2D images without accessing 3D models of teeth and/or without requiring 3D-to-2D registration. This can be faster and less computationally intensive than accessing a 3D model of the patient's teeth and performing a 3D-to-2D registration for every new 2D image.

In some embodiments, the machine learning model is or includes a CNN, e.g., as described above with respect to the machine learning model 404 of the workflow 400 of FIG. 4A. Additionally or alternatively, the machine learning model can be or include a recurrent neural network (RNN), a generative adversarial network (GAN), a capsule network (CapsNet), a graph neural network (GNN), an autoencoder, or a vision transformer (ViT), or any of the other machine learning algorithm types described herein.

The method 500 can continue at block 506 with comparing the determined camera pose with a target camera pose. The target camera pose can be configured to produce a view of the patient that is clinically relevant for diagnostic and/or monitoring purposes, as described elsewhere herein. The process of block 506 can include comparing the determined camera pose to the target camera pose to determine whether there are significant deviations in position and/or orientation. In some embodiments, the comparison can include determining a positional difference between the determined camera pose and the target camera pose. For instance, the determined camera pose may include a first camera position, the target camera pose may include a second camera position, and the comparison may include calculating a positional difference (e.g., in X, Y, and/or Z directions) between the first camera position and the second camera position. Alternatively or in combination, the comparison may include determining an angular difference (e.g., in pitch, yaw, and/or roll) between the determined camera pose and the target camera pose. For instance, the determined camera pose may include a first orientation, the target camera pose may include a second orientation, and the comparison may include calculating an angular difference between the first orientation and the second orientation.

If the determined camera pose differs significantly from the target camera pose (e.g., if the positional difference and/or angular difference between the determined camera pose and the target camera pose exceed a predetermined threshold), the method 500 can continue at block 508 with outputting, via a display, instructions for adjusting the imaging device from the determined camera pose toward the target camera pose. The instructions can include textual indicators (e.g., “tilt left”), graphical indicators (e.g., arrows, symbols, animations, dashes, etc.), audible indicators (e.g., speech, alerts, sounds, etc.), haptic feedback, and/or other indicators suitable for guiding the patient to adjust the camera pose. For instance, in some embodiments, a graphical indicator is displayed on the display. The graphical indicator may be a curved arrow indicating a translation and/or rotation of the imaging device, an alignment target (e.g., crosshairs, tooth outlines) that is overlaid on a real-time video feed of the patient's face, etc.

The display can be associated with a computing device (e.g., a mobile device, personal computer, laptop, tablet, workstation). The computing device may be part of or operably coupled to the imaging device used to obtain the 2D image. For instance, in embodiments where the imaging device is part of a mobile device (e.g., a smartphone camera), the instructions may be shown on a display of the mobile device. The computing device can be part of a computing system (e.g., a virtual dental care system) that includes one or more local client devices (e.g., patient devices and/or clinician devices) communicably coupled to a remote server (e.g., of a dental appliance manufacturer and/or a treatment monitoring service provider) via a communications network. In some embodiments, the computing device used to display the instructions is the same as the computing device used to perform the other processes of the method 500, e.g., all of the processes of the method 500 are performed by a local client device. In other embodiments, the computing device used to display the instructions is different than the computing device used to perform the other processes of the method 500, e.g., the instructions are displayed by a local client device (e.g., mobile phone) and the other processes are performed by a remote server.

In some embodiments, the instructions may be configured to change in response to adjustment of the imaging device. For instance, as the imaging device is moved, the processes of blocks 502-508 can be repeated such that the instructions are updated continuously or substantially continuously. In other embodiments, the instructions are updated only after a new image is captured.

The method 500 can continue at block 510 with obtaining an updated 2D image of the patient's teeth. In some embodiments, the imaging device is instructed to automatically capture the updated 2D image when the imaging device has been readjusted. For instance, upon detecting that the imaging device has been adjusted to the target camera pose, the updated 2D image may be captured. Alternatively or in combination, the user may be instructed to capture the updated 2D image once the imaging device has been adjusted. For instance, the display may provide additional instructions, where the additional instructions indicate that the updated 2D image can be captured. The additional instructions can include textual indicators, graphical indicators, audible indicators, haptic feedback, etc. For example, a green checkmark may appear when the target camera pose has been achieved, and the user may capture the updated 2D image upon seeing the green checkmark.

The method 500 can continue at block 512 with determining treatment progress and/or detecting a disease, a change in the patient, or a condition based on the updated 2D image. In some embodiments, the updated 2D image is sent to the patient's clinician. The clinician may assess the patient's treatment progress and/or dental condition based on the updated 2D image. For instance, the clinician may determine whether the patient's dentition is satisfactorily progressing according to a treatment stage of a treatment plan configured to reposition the patient's teeth. As another example, the clinician may diagnose the patient with an oral disease or condition based on the updated 2D image. Optionally, the clinician may determine that the updated 2D image does not sufficiently capture the patient's intraoral and/or extraoral anatomy, and the patient may be instructed to recapture the image.

Alternatively or in addition, the treatment evaluation and/or monitoring may be completed automatically. For instance, the updated 2D image may be inputted (e.g., uploaded) into a dental evaluation and/or monitoring algorithm, and the dental evaluation and/or monitoring algorithm may be configured to assess the patient's dental condition and predict outcomes of the dental treatment based on the patient's current state. Optionally, the dental evaluation and/or monitoring algorithm may compare the patient's current state, as indicated by the updated 2D image, with a previous patient state, e.g., as indicated by a previous 2D image. Based on the comparison, the dental evaluation algorithm may provide recommendations to the clinician regarding the dental treatment.

The method 500 illustrated in FIG. 5 can be modified in many different ways. For example, the ordering of the processes shown in FIG. 5 can be varied, some of the processes of the method 500 can be omitted, and/or the method 500 can include additional processes not shown in FIG. 1. For instance, the any of the processes of blocks 506, 508, 510, and/or 512 may be omitted from the method 500. Further, the method 500 may include performing one or more image processing operations on the received 2D image of block 502 and/or the updated 2D image of block 510. The image processing operations may include one or more of de-noising, cleaning, segmentation, normalization, thresholding, filtering, downsampling, equalization, or augmentation techniques. Further, while the method 500 is described with respect to a single 2D image, the method 500 can be used to sequentially or concurrently evaluate any suitable number of patient images, such as 2, 5, 10, 20, or more patient images.

Optionally, the method 500 can further include determining a jaw pose for the patient's jaws, comparing the determined jaw pose to a target jaw pose, and outputting instructions for adjusting the determined jaw pose toward the target jaw pose, if appropriate. These processes may be generally similar to the processes of blocks 502-508. For instance, the jaw pose can include a position and orientation of the upper jaw with respect to the lower jaw. In some embodiments, the jaw pose is determined using a trained machine learning model, which may or may not be the same as the machine learning model used to determine the camera pose. Alternatively, the jaw pose may be determined using other techniques, e.g., the camera pose can include a first camera pose representing an estimated spatial relationship between the imaging device and the upper jaw, and a second camera pose representing an estimated spatial relationship between the imaging device and the lower jaw, and the jaw pose can be determined based on the first camera pose and the second camera pose. The determined jaw pose can be compared to a target jaw pose to identify any deviations that may be present. If significant deviations are present, instructions can be output to the patient to guide them in moving their jaws toward the target jaw pose. The processes of jaw pose determination may be performed concurrently or sequentially with the processes of camera pose determination, and may or may not be performed at the same frequency as the camera pose determination.

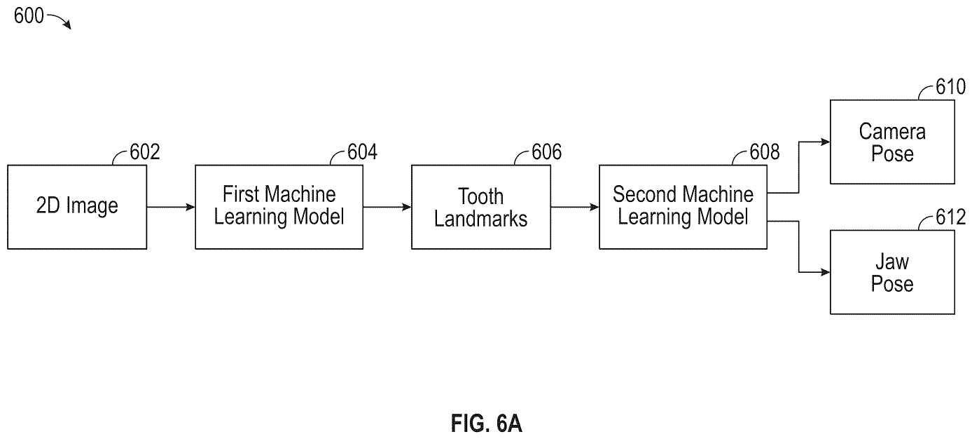

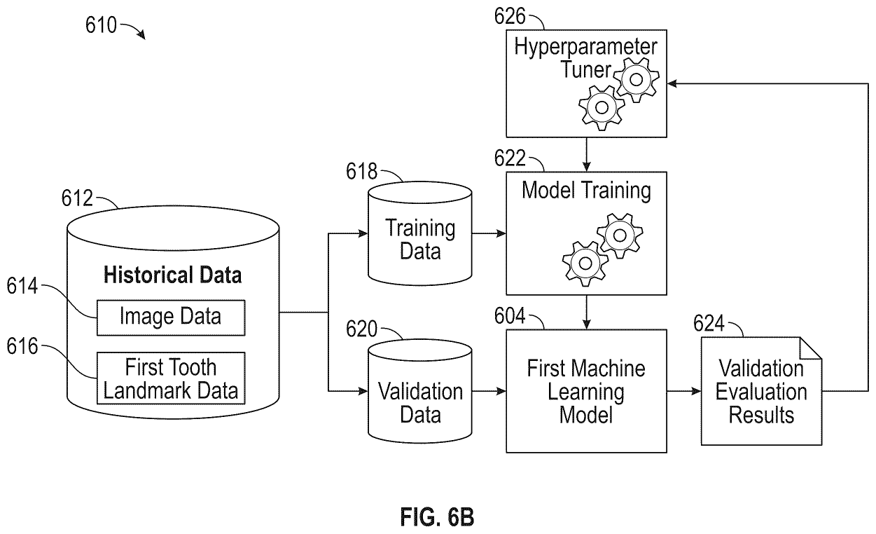

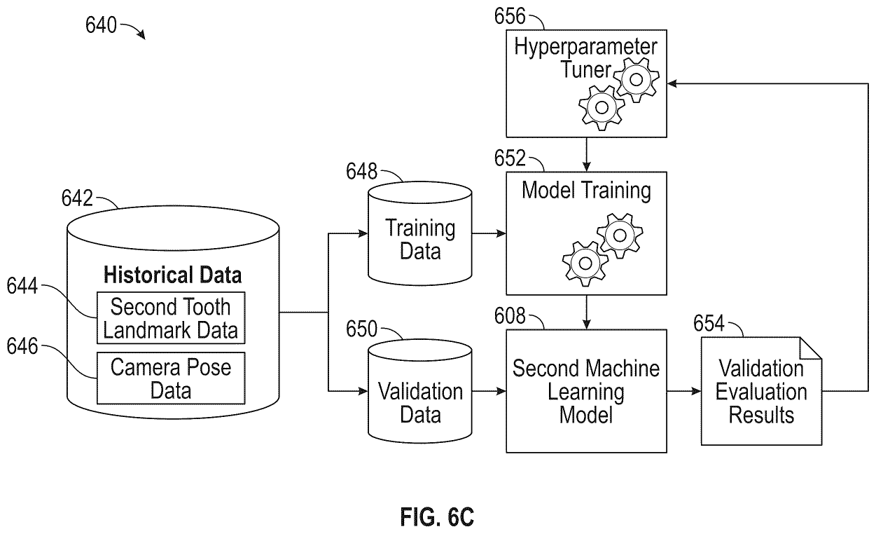

FIG. 6A is a block diagram illustrating a representative example of a workflow 600 for determining camera pose for a patient image, in accordance with embodiments of the present technology. In some embodiments, some or all of the processes described with respect to the workflow 600 are implemented as computer-readable instructions (e.g., program code) that are configured to be executed by one or more processors of a computing device (e.g., a mobile device, laptop, personal computer, workstation, remote server). The computing device may be part of a virtual dental care system as described in, e.g., U.S. Patent Application Publication No. 2022/0023003, the disclosure of which is incorporated by reference herein in its entirety. The workflow 600 can be utilized and/or combined with any of the methods described herein.

The workflow 600 can include receiving at least one 2D image 602 including a depiction of teeth of at least one jaw of a patient. The 2D image 602 can be generally similar to any of the 2D images described herein, such as the 2D image 202 of FIG. 2 and/or the 2D image 402 of FIG. 4A. For instance, the 2D image 602 can include any suitable image data type, such as one or more photographs, one or more frames of a video, etc., any may be a color image, a grayscale image, etc. The 2D image 602 can be received from any suitable imaging device, such as a camera of a mobile device. Optionally, the 2D image 602 may be obtained using the imaging device in combination with an auxiliary device to position the imaging device in a fixed spatial location with respect to the patient's teeth and/or to retract the patient's cheeks and lips to improve visibility of teeth.

The 2D image 602 may depict the patient's mouth region, including the visible portions of the teeth and gingiva, as well as the patient's lips. However, the 2D image 602 may also depict other parts of the patient's anatomy, such as other facial features (e.g., eyes, eyebrows, nose, subnasion, cheeks, chin, jawline), head, neck, shoulders, and/or torso, or the entire body of the patient. The 2D image 602 can depict a profile view of the patient's head, a front view of the patient's head with a neutral expression, a front view of the patient's head while smiling, a view of the upper jaw, a view of the lower jaw, a right buccal view with the jaw closed, an anterior view with the jaw closed, a left buccal view with the jaw closed, a right buccal view with the jaw open, an anterior view with the jaw open, a left buccal view with the jaw open, and/or an occlusal view.

In some embodiments, the imaging device is part of or is operably coupled to a mobile device (e.g., smartphone, tablet), which can be operated by the patient, by a healthcare clinician (e.g., a clinician), or other suitable user. The mobile device can implement a mobile application that instructs the user to capture image data. The image data can be processed locally, e.g., via one or more processors of the mobile device, or the image data may be transmitted to a remote server or computer for processing, or suitable combinations thereof (e.g., some processing may be performed locally and some processing may be performed remotely).

The workflow 600 can further include inputting the 2D image 602 into a first machine learning model 604 to determine a set of tooth landmarks 606 representing geometries and locations of the teeth in the 2D image 602. In some embodiments, the set of tooth landmarks 606 is a tooth segmentation mask, which may be identical or generally similar to the tooth segmentation mask 204 of FIG. 2. For instance, the tooth segmentation mask can include a plurality of tooth masks and/or tooth identifiers for some or all of the teeth in the 2D image 602. Alternatively or in combination, the set of tooth landmarks 606 may include geometrical features such as points (e.g., centroids), lines (e.g., straight lines, curved lines), contours, areas, etc., corresponding to one or more dental landmarks, such as crown centers, central incisors, a jaw center, a dental midline, etc. For instance, individual teeth may be represented by a single point (e.g., a crown center), a single line (e.g., a long axis or a facial axis of the clinical crown (FACC)), or other simplified representation. Moreover, tooth landmarks 606 may be determined only for certain teeth (e.g., the central incisors only) and/or only for certain regions of the jaw (e.g., the midline or jaw center). These approaches may allow for faster and/or simplified image analysis compared to a tooth segmentation mask while still providing basic information on the geometry and location of the teeth (e.g., the distance between tooth centroids may correlate to the size of the teeth).

In some embodiments, the first machine learning model 604 is a trained machine learning model that can determine tooth landmarks directly from 2D images, e.g., without requiring 3D models of the patient's teeth and/or requiring a 3D-to-2D registration process. The first machine learning model 604 can utilize at least one machine learning algorithm, such as any of the following: a regression algorithm (e.g., ordinary least squares regression, linear regression, logistic regression, stepwise regression, multivariate adaptive regression splines, locally estimated scatterplot smoothing), an instance-based algorithm (e.g., k-nearest neighbor, learning vector quantization, self-organizing map, locally weighted learning), regularization algorithms (e.g., ridge regression, least absolute shrinkage and selection operator, elastic net, least-angle regression), a decision tree algorithm (e.g., Iterative Dichotomiser 3 (ID3), C4.5, C5.0, classification and regression trees, chi-squared automatic interaction detection, decision stump, M5), a Bayesian algorithm (e.g., naïve Bayes, Gaussian naïve Bayes, multinomial naïve Bayes, averaged one-dependence estimators, Bayesian belief networks, Bayesian networks, hidden Markov models, conditional random fields), a clustering algorithm (e.g., k-means, single-linkage clustering, k-medians, expectation maximization, hierarchical clustering, fuzzy clustering, density-based spatial clustering of applications with noise (DBSCAN), ordering points to identify cluster structure (OPTICS), non-negative matrix factorization (NMF), latent Dirichlet allocation (LDA), Gaussian mixture model (GMM)), an association rule learning algorithm (e.g., apriori algorithm, equivalent class transformation (Eclat) algorithm, frequent pattern (FP) growth), an artificial neural network algorithm (e.g., perceptrons, neural networks, back-propagation, Hopfield networks, autoencoders, Boltzmann machines, restricted Boltzmann machines, spiking neural nets, radial basis function networks), a deep learning algorithm (e.g., deep Boltzmann machines, deep belief networks, convolutional neural networks, stacked auto-encoders), a dimensionality reduction algorithm (e.g., PCA, independent component analysis (ICA), principle component regression (PCR), partial least squares regression (PLSR), Sammon mapping, multidimensional scaling, projection pursuit, linear discriminant analysis, mixture discriminant analysis, quadratic discriminant analysis, flexible discriminant analysis), an ensemble algorithm (e.g., boosting, bootstrapped aggregation, AdaBoost, blending, gradient boosting machines, gradient boosted regression trees, random forest), or suitable combinations thereof. In some embodiments, the first machine learning model 604 is or includes a CNN, a recurrent neural network (RNN), a generative adversarial network (GAN), a capsule network (CapsNet), a graph neural network (GNN), an autoencoder, or a vision transformer (ViT), e.g., as described elsewhere herein.

In some embodiments, the first machine learning model 604 is a tooth segmentation model (e.g., a neural network) that has been trained on segmented images of teeth. In some embodiments, the machine learning model uses semantic segmentation techniques, e.g., as described in U.S. Patent Application Publication Nos. 2022/0023003 and 2023/0225831, the disclosures of which are incorporated by reference herein in their entirety. Other types of segmentation models that may alternatively or additionally be used for the first machine learning model 604 include, for example, object segmentation models, instance segmentation models, and panoptic segmentation models.

FIG. 6B is a block diagram providing a representative example of a workflow 610 for training the first machine learning model 604 of FIG. 6A via supervised learning, in accordance with embodiments of the present technology. In some embodiments, the first machine learning model 604 is trained using historical data 612 including image data 614 and first tooth landmark data 616. The image data 614 can include a plurality of training images. The training images may include images that have been collected from previous patients and/or images that have been synthetically produced (e.g., 2D images generated from 3D models of teeth rather than actual patient images). The training images may include images taken from a variety of camera poses. For instance, the training images may differ in position and/or orientation of the imaging device used to capture the training images. In some embodiments, the training images include images captured from a frontal view, images captured from a buccal view, images captured from a posterior view, images captured from an occlusal view, etc. The first tooth landmark data 616 can include a corresponding set of training tooth landmarks for each training image of the plurality of training images of the image data 614. The training tooth landmarks can include tooth segmentation masks and/or other dental landmarks, and may be generated by manual annotation of the training images.

The historical data 612 can be partitioned into training data 618 and validation data 620. The training data 618 can include annotated image data and select tooth landmark data that are used in a model training process 622 to train the first machine learning model 604. The model training process 622 may include learning associations between the annotated image data and the select tooth landmark data of the training data 618. The validation data 620 can include annotated image data and tooth landmark data that are not used in the model training process 622. In some embodiments, the validation data 620 is used to retrain the first machine learning model 604. For instance, the annotated image data of the validation data 620 can be input into the first machine learning model 604, and the first machine learning model 604 can generate predicted tooth landmark data based on the annotated image data of the validation data 620. The predicted tooth landmark data can be compared to the tooth landmark data of the validation data 620 to produce validation evaluation results 624. The validation evaluation results 624 can take any form, such as a loss (e.g., error) between the predicted tooth landmark data and the tooth landmark data of the validation data 620. Based on the loss, hyperparameters of the first machine learning model 604 can be tuned via a hyperparameter tuner 626, and the model can be retrained until the validation evaluation results 624 are satisfactory. In some embodiments, the validation evaluation results 624 are satisfactory when the loss is below a predetermined error tolerance. The processes described above with respect to FIG. 6B are provided as examples; any number of additional or alternative training processes are possible.

Referring again to FIG. 6A, the workflow 600 can further include inputting the set of tooth landmarks 606 into a second machine learning model 608 to determine a camera pose 610 representing an estimated spatial relationship between the imaging device and the at least one jaw in the 2D image 608. In some embodiments, the second machine learning model 608 is a trained machine learning model that can determine camera poses directly from tooth landmarks (e.g., a camera pose estimation model) without requiring 3D models of the patient's teeth and/or requiring a 3D-to-2D registration process. The input data to the second machine learning model 608 may include only the tooth landmarks 606, or may include other types of data (e.g., image metadata including intrinsic camera parameters (e.g., focal length, aperture, optical axis, center of projection, or principal point of the imaging device), motion data of the imaging device, a previous camera pose of the imaging device).

In some embodiments, the second machine learning model 608 utilizes at least one machine learning algorithm, such as any the machine learning algorithms described herein, e.g., with respect to the first machine learning model 604. The second machine learning model 608 may use the same type of machine learning algorithm as the first machine learning model 604, or may use a different type of machine learning algorithm.

FIG. 6C is a block diagram providing a representative example of a workflow 640 for training the second machine learning model 608 of FIG. 6A via supervised learning, in accordance with embodiments of the present technology. In some embodiments, the second machine learning model 608 is trained using historical data 642 including second tooth landmark data 644 and camera pose data 646. The second tooth landmark data 644 may be the same as the first tooth landmark data 616 or may be different from the first tooth landmark data 616. The second tooth landmark data 644 and the camera pose data 646 may include synthetic training data. For instance, 3D models of teeth can be used to sample a plurality of camera poses, e.g., by projecting the 3D models into a 2D space using different camera parameters to generate synthetic 2D images of the 3D models. The camera poses can be sampled randomly, or the camera poses can be sampled in accordance with one or more imaging constraints (e.g., intrinsic parameters of the imaging device such as focal length, aperture, optical axis, center of projection, or principal point of the imaging device). The second tooth landmark data 644 can then be determined from the synthetic 2D images, e.g., using tooth segmentation models and/or other approaches as described herein.

Additionally or alternatively, the second tooth landmark data 644 and the camera pose data 646 can be generated from previous patient data. For instance, the second tooth landmark data 644 can be generated from the previous 2D images of patient teeth, e.g., via a segmentation model and/or other approaches described herein. The camera pose data 646 can be determined from the 2D images, e.g., using a 3D-to-2D registration as previously described with respect to the workflow 200 of FIG. 2 and/or the method 300 of FIG. 3.

The historical data 642 can be partitioned into training data 648 and validation data 650. The training data 648 can include annotated image data and select tooth landmark data that are used in a model training process 652 to train the second machine learning model 608. The model training process 652 may include learning associations between the annotated image data and the select tooth landmark data of the training data 648. The validation data 650 can include annotated image data and tooth landmark data that are not used in the model training process 652. In some embodiments, the validation data 650 is used to retrain the second machine learning model 608. For instance, the annotated image data of the validation data 650 can be input into the second machine learning model 608, and the second machine learning model 608 can generate predicted tooth landmark data based on the annotated image data of the validation data 650. The predicted tooth landmark data can be compared to the tooth landmark data of the validation data 650 to produce validation evaluation results 654. The validation evaluation results 654 can take any form, such as a loss (e.g., error) between the predicted tooth landmark data and the tooth landmark data of the validation data 650. Based on the loss, hyperparameters of the second machine learning model 608 can be tuned via a hyperparameter tuner 656, and the model can be retrained until the validation evaluation results 654 are satisfactory. In some embodiments, the validation evaluation results 654 are satisfactory when the loss is below a predetermined error tolerance. The processes described above with respect to FIG. 6B are provided as examples; any number of additional or alternative training processes are possible.

Referring again to FIG. 6A, after the second machine learning model 608 has been trained, the second machine learning model 608 can be configured to determine camera poses from tooth landmarks without accessing 3D models of teeth. In some embodiments, the output of the second machine learning model 608 is used directly as the camera pose 610. In other embodiments, the output of the second machine learning model 608 may be processed to determine the camera pose 610, e.g., intrinsic camera parameters such as focal length may be used to calculate the camera pose 610.

Optionally, in embodiments where the 2D image 602 depicts both jaws of the patient, the workflow 600 can further include determining a jaw pose 612. The jaw pose 612 may be determined by the same second machine learning model 608 used to determine the camera pose 610 or may be determined by a different machine learning model. In such embodiments, the machine learning model can be trained on second tooth landmark data and jaw pose data, e.g., similar to the training of the second machine learning model 608 discussed above with respect to FIG. 6C. Alternatively, the jaw pose 612 may be determined using other techniques, e.g., the camera pose 610 can include a first camera pose representing an estimated spatial relationship between the imaging device and the upper jaw, and a second camera pose representing an estimated spatial relationship between the imaging device and the lower jaw, and the jaw pose 612 can be determined based on the first camera pose and the second camera pose.

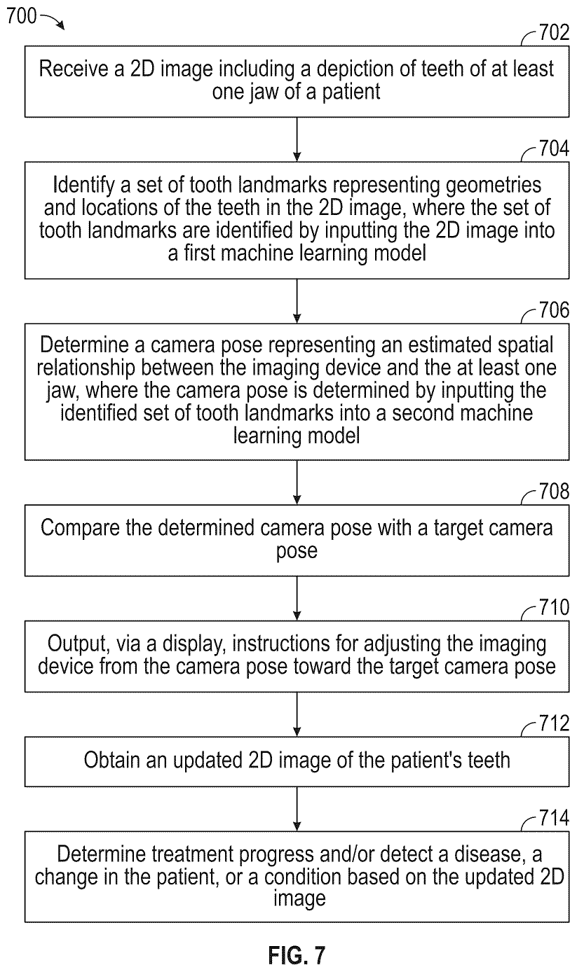

FIG. 7 is a flow diagram illustrating a method 700 for determining camera pose for a patient image, in accordance with embodiments of the present technology. In some embodiments, some or all of the processes described with respect to the method 700 are implemented as computer-readable instructions (e.g., program code) that are configured to be executed by one or more processors of a computing device (e.g., a mobile device, laptop, personal computer, workstation, remote server). The computing device may be part of a virtual dental care system as described in, e.g., U.S. Patent Application Publication No. 2022/0023003, the disclosure of which is incorporated by reference herein in its entirety. The method 700 can be utilized and/or combined with any of the methods described herein, e.g., the method 700 may be performed in combination with the workflow 600 of FIG. 6A.

The method 700 can begin at block 702 with receiving a 2D image including a depiction of teeth of at least one jaw of a patient. The 2D image can be generally similar to any of the 2D images described herein, such as the 2D image 202 of the workflow 200 of FIG. 2, the 2D image 402 of the workflow 400 of FIG. 4A, or the 2D image 602 of the workflow 600 of FIG. 6A. For instance, the 2D image can include any suitable image data type, such as one or more photographs, one or more frames of a video, etc., and may be a color image, a grayscale image, etc. The 2D image can be received from any suitable imaging device, such as a camera of a mobile device. Optionally, the 2D image may be obtained using the imaging device in combination with an auxiliary device to position the imaging device in a fixed spatial location with respect to the patient's teeth and/or to retract the patient's cheeks and lips to improve visibility of teeth. In some embodiments, the 2D image may depict the patient's mouth region, including the visible portions of the teeth and gingiva, as well as the patient's lips. However, the 2D image may also depict other parts of the patient's anatomy, such as other facial features (e.g., eyes, eyebrows, nose, subnasion, cheeks, chin, jawline), head, neck, shoulders, and/or torso, or the entire body of the patient.

The 2D image can be taken from a variety of camera poses, and the patient can assume a variety of facial expressions. For instance, the 2D image can depict a profile view of the patient's head, a front view of the patient's head with a neutral expression, a front view of the patient's head while smiling, a view of the upper jaw, a view of the lower jaw, a right buccal view with the jaw closed, an anterior view with the jaw closed, a left buccal view with the jaw closed, a right buccal view with the jaw open, an anterior view with the jaw open, a left buccal view with the jaw open, and/or an occlusal view. Further, the 2D image may be captured as part of a series of images, e.g., as described elsewhere herein.

In some embodiments, the imaging device is part of or is operably coupled to a mobile device (e.g., smartphone, tablet), which can be operated by the patient, by a healthcare provider (e.g., a clinician), or other suitable user. The mobile device can implement a mobile application that instructs the user to capture image data. The image data can be processed locally, e.g., via one or more processors of the mobile device, the image data may be transmitted to a remote server or computer for processing, or suitable combinations thereof (e.g., some processing may be performed locally and some processing may be performed remotely).

The method 700 can continue at block 704 with identifying a set of tooth landmarks representing geometries and locations of the teeth in the 2D image. The set of tooth landmarks can be or include a tooth segmentation mask, e.g., which may be identical or generally similar to the tooth segmentation mask 204 of FIG. 2. Alternatively or in combination, the set of tooth landmarks may include geometrical features corresponding to one or more dental landmarks, such as crown centers, central incisors, a jaw center, a dental midline, etc. The tooth landmarks may be determined for all teeth, or only for certain teeth and/or only for certain regions of the jaw.

In some embodiments, the set of tooth landmarks is determined by inputting the 2D image into a first machine learning model configured to predict tooth landmarks from 2D images. The first machine learning model may be trained using image data and first tooth landmark data, e.g., as previously discussed with respect to the workflow 600 of FIG. 6A. For instance, the image data may include a plurality of training images that have been collected from previous patients and/or images that have been synthetically produced (e.g., generated), and the first tooth landmark data may include a corresponding set of training tooth landmarks for each training image, where the training tooth landmarks for each training image are generated via manual annotation. In some embodiments, the first machine learning model is a tooth segmentation model, such as a semantic segmentation model, an object segmentation model, an instance segmentation model, a panoptic segmentation model, etc. After the first machine learning model has been trained using the image data and the first tooth landmark data, the first machine learning model can be configured to predict tooth landmarks from 2D images, e.g., without 3D models and/or 3D-to-2D registration.

The method 700 can continue at block 706 with determining a camera pose representing an estimated spatial relationship between the imaging device and the at least one jaw. In some embodiments, the camera pose is determined by inputting the set of tooth landmarks into a second machine learning model that is trained to predict camera pose from tooth landmarks. For example, the second machine learning model can be a CNN, a recurrent neural network (RNN), a generative adversarial network (GAN), a capsule network (CapsNet), a graph neural network (GNN), an autoencoder, or a vision transformer (ViT), or any of the other machine learning algorithm types described herein. The second machine learning model can be trained using second tooth landmark data and camera pose data, e.g., as previously discussed with respect to the workflow 600 of FIG. 6A. For instance, the second tooth landmark data and the camera pose data can be derived from images based on previous patient data (e.g., previous 2D images of patient teeth) and/or synthetic data synthetic data (e.g., 2D images of 3D models of teeth).

The method 700 can continue at block 708 with comparing the determined camera pose with a target camera pose. The process of block 708 may be identical or generally similar to the process of block 506 of the method 500 of FIG. 5. For example, the target camera pose can be configured to produce a produce a view of the patient that is clinically relevant for diagnostic and/or monitoring purposes, and the process of block 708 can include comparing the determined camera pose to the target camera pose to determine whether there are significant deviations in position and/or orientation.

If the determined camera pose differs significantly from the target camera pose (e.g., if the positional difference and/or angular difference between the determined camera pose and the target camera pose exceed a predetermined threshold), the method 700 can continue at block 710 with outputting, via a display, instructions for adjusting the image device from the camera pose toward the target camera pose. The process of block 710 may be identical or generally similar to the process of block 508 of the method 500 of FIG. 5. For instance, the instructions can include textual indicators, graphical indicators, audible indicators, haptic feedback, etc., and can be shown on a display associated with a computing device (e.g., a mobile device, personal computer, laptop, tablet, workstation). The computing device may be part of or operably coupled to the imaging device used to obtain the 2D image.

The method 700 can continue at block 712 with obtaining an updated 2D image of the patient's teeth. The process of block 712 may be identical or generally similar to the process of block 510 of the method 500 of FIG. 5. For instance, the updated 2D image may be captured automatically by the imaging device or the user may be prompted to obtain the updated 2D image once the imaging device has been adjusted.

The method 700 can continue at block 714 with determining treatment progress and/or detecting a disease, a change in the patient, or a condition based on the updated 2D image. The process of block 714 may be identical or generally similar to the process of block 512 of the method 500 of FIG. 5. In some embodiments, the updated 2D image is analyzed by a clinician and/or a software algorithm determine whether the patient's dentition is satisfactorily progressing according to a treatment plan, to diagnose the patient with an oral disease or condition based on the updated 2D image, to provide treatment recommendations, etc.

The method 700 illustrated in FIG. 7 can be modified in many different ways. For example, the ordering of the processes shown in FIG. 7 can be varied, some of the processes of the method 700 can be omitted, and/or the method 700 can include additional processes not shown in FIG. 1. For instance, any of the processes of blocks 708,710, 712, and/or 714 may be omitted from the method 700. The method 700 may also include performing one or more image processing operations on the received 2D image of block 702 and/or the updated 2D image of block 710. The image processing operations may include one or more of de-noising, cleaning, segmentation, normalization, thresholding, filtering, downsampling, equalization, or augmentation techniques. Further, while the method 700 is described with respect to a single 2D image, the method 700 can be used to sequentially or concurrently evaluate any suitable number of patient images, such as 2, 5, 10, 20, or more patient images.

Optionally, the method 700 can further include determining a jaw pose for the patient's jaws, comparing the determined jaw pose to a target jaw pose, and outputting instructions for adjusting the determined jaw pose toward the target jaw pose, if appropriate. These processes may be generally similar to the processes of blocks 702-710. For instance, the jaw pose can include a position and orientation of the upper jaw with respect to the lower jaw. In some embodiments, the jaw pose is determined using a trained machine learning model, which may or may not be the same as the second machine learning model used to determine the camera pose. Alternatively, the jaw pose may be determined using other techniques, e.g., the camera pose can include a first camera pose representing an estimated spatial relationship between the imaging device and the upper jaw, and a second camera pose representing an estimated spatial relationship between the imaging device and the lower jaw, and the jaw pose can be determined based on the first camera pose and the second camera pose. The determined jaw pose can be compared to a target jaw pose to identify any deviations that may be present. If significant deviations are present, instructions can be output to the patient to guide them in moving their jaws toward the target jaw pose. The processes of jaw pose determination may be performed concurrently or sequentially with the processes of camera pose determination, and may or may not be performed at the same frequency as the camera pose determination.

In some embodiments, the present technology provides systems and methods for evaluating whether a patient image is acceptable, e.g., for clinical purposes. For instance, it may be desirable for the patient image to depict particular regions of the dental anatomy that allow the clinician to monitor and/or diagnose a condition of the patient's teeth. If the particular regions are depicted adequately in the patient image, the patient image may be deemed acceptable. On the other hand, if the particular dental anatomies are not clearly shown in the patient image, not shown at all, and/or the patient image is of inferior quality (e.g., the image is out of focus, blurred, too large, too small, etc.), the patient image may be deemed unacceptable for clinical purposes.

This acceptability check can be performed by automated software algorithms (e.g., machine learning models) that compare the patient image against one or more acceptability parameters, as will be described further below. Conventional algorithms for evaluating acceptability typically have a “hard” threshold in that either an image is accepted or is not accepted. However, this all or nothing approach may not be appropriate in some instances, since dental anatomies may vary between patients, patients may use different imaging devices, etc. For instance, a patient may be missing one or more teeth, and the software algorithm may always determine that an image of the patient's teeth is unacceptable because of the missing teeth. If repeated attempts to capture an acceptable image are unsuccessful, the only option may be to turn all checks completely off, in which case the resulting image may be unsatisfactory for clinical purposes.

The present technology can address these and other challenges by providing systems and methods for evaluating patient images with a dynamic threshold for acceptability. For instance, the threshold for acceptability may vary over time to reduce frustration and improve user experience, e.g., the threshold is lowered if repeated attempts to capture images are unsuccessful to ensure that the image will pass the check at some point. As another example, the threshold may be customized to the particular patient, e.g., based on the patient's anatomy (e.g., thresholds may be lowered for more challenging and/or atypical anatomy), imaging device, clinician preference, etc. In a further example, the threshold may be customized for different acceptability parameters.

FIG. 8 is a flow diagram illustrating a method 800 for evaluating an acceptability of a patient image, in accordance with embodiments of the present technology. In some embodiments, some or all of the processes described with respect to the method 800 are implemented as computer-readable instructions (e.g., program code) that are configured to be executed by one or more processors of a computing device (e.g., a mobile device, laptop, personal computer, workstation, remote server). The computing device may be part of a virtual dental care system as described in, e.g., U.S. Patent Application Publication No. 2022/0023003, the disclosure of which is incorporated by reference herein in its entirety. The method 800 can be utilized and/or combined with any of the methods described herein, such as any of the methods discussed with respect to FIGS. 2-7 above.

The method 800 can begin at block 802 with receiving a 2D image including a depiction of teeth of at least one jaw of a patient. The 2D image can be generally similar to any of the 2D images described herein, such as the 2D image 202 of the workflow 200 of FIG. 2, the 2D image 402 of the workflow 400 of FIG. 4A, and/or the 2D image 602 of the workflow 600 of FIG. 6A. For instance, the 2D image can include any suitable image data type, such as one or more photographs, one or more frames of a video, etc., and may be a color image, a grayscale image, etc. The 2D images can be received from any suitable imaging device, such as a camera of a mobile device. Optionally, the 2D images may be obtained using the imaging device in combination with an auxiliary device to position the imaging device in a fixed spatial location with respect to the patient's teeth and/or to retract the patient's cheeks and lips to improve visibility of teeth. In some embodiments, the 2D image may depict the patient's mouth region, including the visible portions of the teeth and gingiva, as well as the patient's lips. However, the 2D image may also depict other parts of the patient's anatomy, such as other facial features (e.g., eyes, eyebrows, nose, subnasion, cheeks, chin, jawline), head, neck, shoulders, and/or torso, or the entire body of the patient.

In some embodiments, the imaging device is part of or is operably coupled to a mobile device (e.g., smartphone, tablet), which can be operated by the patient, by a healthcare provider (e.g., a clinician), or other suitable user. The mobile device can implement a mobile application that instructs the user to capture image data. The image data can be processed locally, e.g., via one or more processors of the mobile device, the image data may be transmitted to a remote server or computer for processing, or suitable combinations thereof (e.g., some processing may be performed locally and some processing may be performed remotely).

The method 800 can continue at block 804 with evaluating whether the 2D image is acceptable. Some example methods for evaluating image quality are described in U.S. Patent Publication No. 2024/0122463 and U.S. Provisional Patent Application No. 63/561,123. The process of block 804 can include determining whether the 2D image satisfies an image acceptability threshold. In some embodiments, the 2D image may satisfy the image acceptability threshold if the 2D image is suitable for clinical purposes. Evaluating whether the 2D image satisfies the image acceptability threshold can include calculating an image acceptability parameter for the 2D image, and comparing the image acceptability parameter to the image acceptability threshold.

In some embodiments, the image acceptability parameter is or includes a similarity parameter between a camera pose and/or jaw pose of the 2D image and a target camera pose and/or target jaw pose. For instance, the camera pose and/or the jaw pose of the 2D image can be determined using any of the processes described herein, such as any of the processes of the workflows and/or methods described in connection with FIGS. 2-7. The determined camera pose and/or the determined jaw pose can be compared to a target camera pose and/or a target jaw pose, e.g., as described elsewhere herein. In some embodiments, the comparison includes measuring a positional and/or angular difference between the determined camera pose and the target camera pose and/or between the determined jaw pose and the target jaw pose. The measured positional and/or angular difference can be inversely related to the similarity parameter. For instance, where a measured positional distance between the determined camera pose and the target camera pose is high, the similarity score can be low and the 2D image may be deemed unsatisfactory.

In some embodiments, the image acceptability parameter is or includes a feature quality parameter. The feature quality parameter may indicate how well the 2D image depicts a clinically relevant feature of interest (e.g., a particular tooth, a particular jaw pose). The feature quality parameter may be determined by inputting the 2D image into a feature evaluation algorithm (e.g., a machine learning algorithm) that is configured to identify the feature of interest in the 2D image and evaluate whether the feature is satisfactorily depicted in the 2D image (e.g., based on feature size, whether the feature is obscured or not, whether the feature is blurred or not). The feature evaluation algorithm may output a numerical score or other metric characterizing how well the feature of interest is depicted in the 2D image.

Additionally or alternatively, the image acceptability parameter can be or include an image quality parameter that is indicative of various characteristics of the 2D image, such as noise (e.g., signal-to-noise ratio), sharpness, contrast, color accuracy, resolution, clarity, artifacts, range, aberration, etc.

Any of the image acceptability parameters described herein can be provided in any suitable format, such as a quantitative metric (e.g., a score, percentage, probability, loss metric, distance) or a qualitive metric (e.g., a rating, categorization, description). For example, the image acceptability parameter may be a numeric value within a range from 0 to 1, where 0 is unacceptable and 1 is ideal and/or satisfactory. Many suitable ranges may be used to capture the variation in the acceptability parameter. For example, the image acceptability parameter may be within a range from 0 to 10, 0 to 20, 0 to 50, 0 to 100, etc. As another example, the image acceptability parameter for the 2D image can be a rating such as “bad,” “good,” “great,” “near perfect,” “perfect,” etc.

In some embodiments, each image acceptability parameter is compared to a respective image acceptability threshold, e.g., a maximum deviation between a current camera pose and a target camera pose, a minimum distance between the upper and lower jaws for an open bite image, a minimum score for imaging quality, etc. Alternatively, some or all of the image acceptability parameters may be combined (e.g., via averaging, summation, or any other suitable function), and the output of the combination may be compared to a single image acceptability threshold. Although certain aspects of the following discussion are framed in terms of a single image acceptability threshold, this is not intended to be limiting, and the present technology contemplates multiple image acceptability thresholds that may be adjusted independently of each other.

In some embodiments, the image acceptability threshold has an initial value that is customized based on one or more patient-specific factors, such as the patient's medical data (e.g., medical history, dental scans), demographic data (e.g., age, gender, race/ethnicity), environmental data (e.g., water quality, diet), and/or anatomical structures of interest (e.g., an image acceptability threshold for a particular tooth may be different than an image acceptability threshold for the entirety of the patient's jaw). For instance, in some examples, the initial value of the image acceptability threshold is decreased if it is known from previous dental scans that the patient has a dentition that greatly deviates from a standard dentition. Alternatively or additionally, the initial value of the image acceptability threshold may be lowered if the patient is a pediatric patient, since the patient's dentition may not be fully set. Alternatively or additionally, the initial value of the image acceptability threshold can be increased if it is known from previous dental scans that the patient has completed orthodontic treatment, etc. The initial value for the image acceptability threshold may also be set based on clinician input, e.g., if the clinician has any particular preferences for image acceptability, if the clinician is aware that the particular patient has atypical anatomy, etc. In other embodiments, however, the initial value for the image acceptability threshold may be a standard value, e.g., the same initial value is used for all patients.

In some embodiments, the image acceptability threshold has an initial value that is determined by an automated software algorithm based on the 2D image and, optionally, other input data (e.g., image metadata including intrinsic camera parameters (e.g., focal length, aperture, optical axis, center of projection, or principal point of the imaging device), clinical information (e.g., medical data, previous scans)). For instance, a machine learning model can be trained using image data and image acceptability threshold data. The image data may include a plurality of training images, and the image acceptability threshold data may include a range of image acceptability thresholds for each of the training images. In some embodiments, the range of image acceptability thresholds may include a target threshold (e.g., an image acceptability threshold that balances how clinically relevant an image is with how long and/or how many attempts it takes to capture the image). The machine learning model may learn associations between types of dental conditions and suitable image acceptability thresholds. For instance, the machine learning model may associate images of patients missing posterior teeth with more lenient (e.g., lower) image acceptability thresholds. After the machine learning model has been trained using the image data and image acceptability threshold data, the machine learning model can be configured to determine a target threshold for an input 2D image. The target threshold can be used as the initial value of the image acceptability threshold.

In response to a determination that the 2D image is acceptable (e.g., the image acceptability parameter satisfies the image acceptability threshold), the method 800 can terminate at block 806. In some embodiments, terminating the method 800 further includes storing the 2D image, e.g., on a device coupled to the imaging device and/or on a remote server. Alternatively or in combination, terminating the method 800 can include sending the 2D image to the clinician for further examination. For instance, the 2D image may be uploaded to a computing device of the clinician and/or to a remote server that is accessible by the clinician's computing device. The clinician and/or an automated algorithm may evaluate the 2D image to monitor the patient's treatment progress with respect to a dental treatment plan and/or to diagnose a disease or condition, etc. as discussed elsewhere herein. Alternatively or additionally, terminating the method 800 at the block 806 can include post-processing the 2D image. For instance, the 2D image may be denoised, cleaned, segmented, normalized, thresholded, filtered, downsampled, equalized, or otherwise augmented.

Returning to block 804, in response to a determination that the 2D image is not acceptable (e.g., the image acceptability parameter does not satisfy the image acceptability threshold), the method 800 can continue at block 808 with decreasing the image acceptability threshold from the initial value to a reduced value. The extent of the decrease may be varied as desired, and may depend on the time elapsed since the imaging process began, the number of unsuccessful attempts, how close the image was to being acceptable, etc. For instance, it may be desirable to have smaller decreases initially, and then have larger decreases over time and/or after a significant number of failed attempts to reduce patient frustration. As another example, if the image failed the acceptability check by only a small amount, it may not be necessary to significantly decrease the image acceptability threshold. In some embodiments, the decreases may only be made after one or more threshold conditions have been met (e.g., after a threshold amount of time has elapsed and/or after a threshold number of failed attempts have occurred).

In some embodiments, image acceptability is evaluated using the formula

$${A}_{i} ( image ) > {T}_{i} ( t ) ∀ i$$

where Aᵢ(image) is an image acceptability parameter for the 2D image, and Tᵢ(t) represents the image acceptability threshold of a given acceptability parameter i over time t and decreases with increasing time.

In some embodiments, the image acceptability threshold can be decreased exponentially. For instance, the predetermined threshold can be decreased according to an exponential falloff, e.g., as characterized by:

$${T}_{i} ( t ) = {T}_{i} * exp ( - r * t )$$

where Tᵢ(t) represents the image acceptability threshold of a given acceptability parameter i over time t, Tᵢ represents a nominal acceptability threshold, such as an initial threshold, and r represents a constant rate.

Alternatively or additionally, the predetermined threshold can be decreased according to a modified exponential falloff, e.g., as characterized by:

$${T}_{i} ( t ) = ( {T}_{i} - {T}_{min} ) * exp ( - r * t ) + {T}_{min}$$

where Tᵢ(t) represents the image acceptability threshold of a given acceptability parameter i over time t, Tᵢ represents a nominal acceptability threshold, Tₘᵢₙ represents a minimum threshold, and r represents a constant rate.

Alternatively or additionally, the predetermined threshold can be decreased according to a percentile falloff, e.g., as characterized by:

$${T}_{i} ( t ) = {H}^{- 1} ( V - r * t )$$

where Tᵢ(t) represents the image acceptability threshold of a given acceptability parameter i over time t, H⁻¹(p) represents the p-th percentile threshold over a prior set of data where p is greater than or equal to 0, V is a nominal percentile (e.g., 50^{th} percentile), and r represents a constant rate. Alternatively or additionally, the predetermined threshold can be decreased by one or more of the following: a sigmoidal falloff, a stepwise falloff, a linear falloff, a polynomial falloff, etc.

After the image acceptability threshold has been decreased, the method 800 can return to block 802 with receiving an additional 2D image comprising a depiction of the patient's teeth. The method 800 may repeat the processes of blocks 802-808 until a 2D image that satisfies the image acceptability threshold is received. Further, instead of decreasing the image acceptability threshold based on time alone, the image acceptability threshold may additionally or alternatively be decreased based on the number of determinations that the 2D image does not satisfy the image acceptability threshold. For instance, the image acceptability threshold may be decreased after 1, 2, 3, 4, 5, 10, 20, or more unsatisfactory determinations. Moreover, the image acceptability threshold may be decreased for only some image acceptability parameters but not for all. For instance, if an image acceptability parameter related to evaluating the posterior teeth continues to fail while an image acceptability parameter related to evaluating an open bite continues to pass, the image acceptability threshold for the posterior teeth evaluation may decrease while the image acceptability threshold for the open bite evaluation may stay the same.

The method 800 illustrated in FIG. 8 can be modified in many different ways. For example, the ordering of the processes shown in FIG. 8 can be varied, some of the processes of the method 800 can be omitted, and/or the method 800 can include additional processes not shown in FIG. 8. For instance, the method 800 may include one or more image processing operations on the received 2D image in block 802. The image processing operations may include one or more of de-noising, cleaning, segmentation, normalization, thresholding, filtering, downsampling, equalization, or augmentation techniques. Moreover, the method 800 may further include monitoring progress of the patient's teeth with respect to a treatment plan and/or detecting a disease or condition based on the 2D image. Further, while the method 800 is described with respect to a single 2D image, the method 800 can be used to sequentially or concurrently evaluate any suitable number of patient images, such as 2, 5, 10, 20, or more patient images.

### II. Dental Appliances and Associated Methods

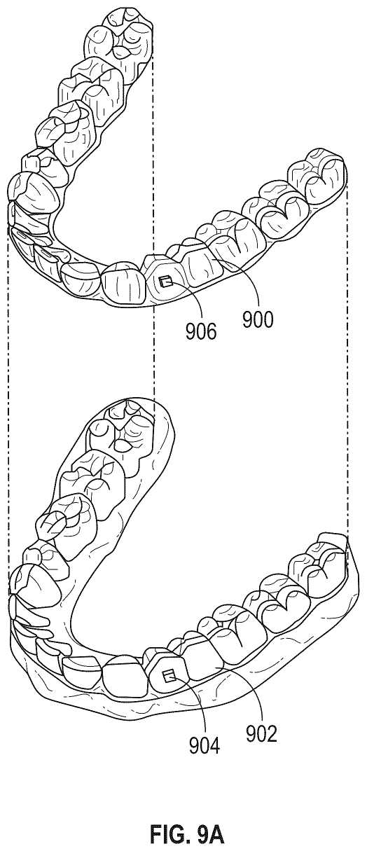

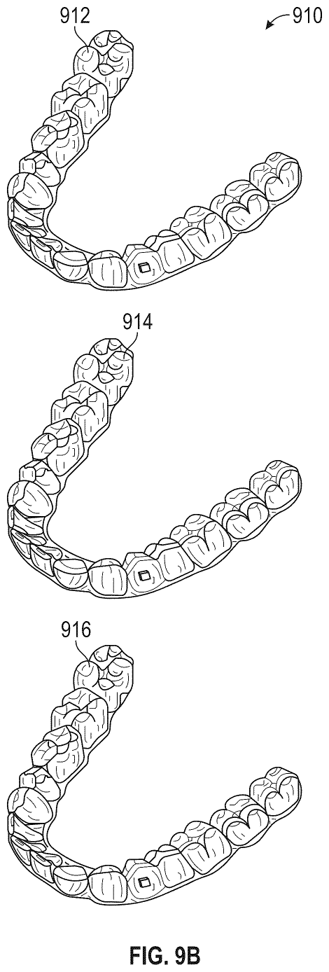

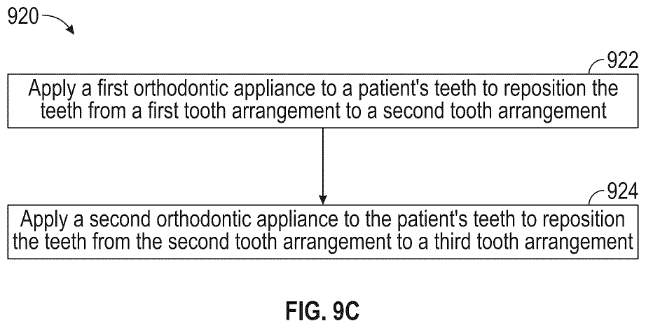

FIG. 9A illustrates a representative example of a tooth repositioning appliance 900 configured in accordance with embodiments of the present technology. The appliance 900 can be used in combination with any of the systems, methods, and devices described herein. The appliance 900 (also referred to herein as an “aligner”) can be worn by a patient in order to achieve an incremental repositioning of individual teeth 902 in the jaw. The appliance 900 can include a shell (e.g., a continuous polymeric shell or a segmented shell) having teeth-receiving cavities that receive and resiliently reposition the teeth. The appliance 900 or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using additive manufacturing techniques, from a digital model of an appliance.

The appliance 900 can fit over all teeth present in an upper or lower jaw, or less than all of the teeth. The appliance 900 can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance 900 can be a generic appliance configured to receive the teeth, but not necessarily shaped to match the topography of the patient's teeth. In some cases, only certain teeth received by the appliance 900 are repositioned by the appliance 900 while other teeth can provide a base or anchor region for holding the appliance 900 in place as it applies force against the tooth or teeth targeted for repositioning. In some cases, some, most, or even all of the teeth can be repositioned at some point during treatment. Teeth that are moved can also serve as a base or anchor for holding the appliance as it is worn by the patient. In preferred embodiments, no wires or other means are provided for holding the appliance 900 in place over the teeth. In some cases, however, it may be desirable or necessary to provide individual attachments 904 or other anchoring elements on teeth 902 with corresponding receptacles 906 or apertures in the appliance 900 so that the appliance 900 can apply a selected force on the tooth. Representative examples of appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 9B illustrates a tooth repositioning system 910 including a plurality of appliances 912, 914, 916, in accordance with embodiments of the present technology. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 910 can include a first appliance 912 corresponding to an initial tooth arrangement, one or more intermediate appliances 914 corresponding to one or more intermediate arrangements, and a final appliance 916 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 9C illustrates a method 920 of orthodontic treatment using a plurality of appliances, in accordance with embodiments of the present technology. The method 920 can be practiced using any of the appliances or appliance sets described herein. In block 922, a first orthodontic appliance is applied to a patient's teeth in order to reposition the teeth from a first tooth arrangement to a second tooth arrangement. In block 924, a second orthodontic appliance is applied to the patient's teeth in order to reposition the teeth from the second tooth arrangement to a third tooth arrangement. The method 920 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

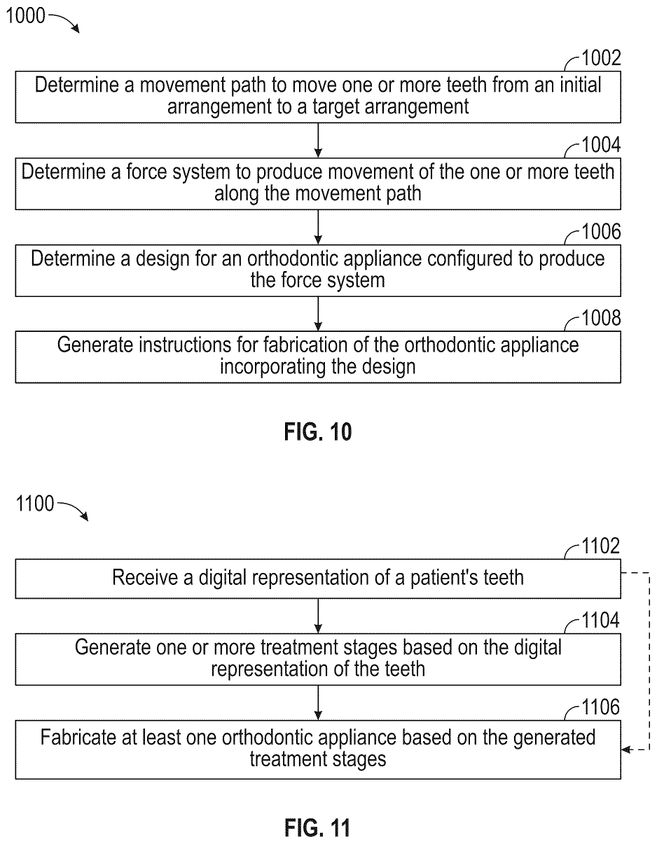

FIG. 10 illustrates a method 1000 for designing an orthodontic appliance, in accordance with embodiments of the present technology. The method 1000 can be applied to any embodiment of the orthodontic appliances described herein. Some or all of the steps of the method 1000 can be performed by any suitable data processing system or device, e.g., one or more processors configured with suitable instructions.

In block 1002, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In block 1004, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

Determination of the force system can be performed in a variety of ways. For example, in some embodiments, the force system is determined on a patient-by-patient basis, e.g., using patient-specific data. Alternatively or in combination, the force system can be determined based on a generalized model of tooth movement (e.g., based on experimentation, modeling, clinical data, etc.), such that patient-specific data is not necessarily used. In some embodiments, determination of a force system involves calculating specific force values to be applied to one or more teeth to produce a particular movement. Alternatively, determination of a force system can be performed at a high level without calculating specific force values for the teeth. For instance, block 1004 can involve determining a particular type of force to be applied (e.g., extrusive force, intrusive force, translational force, rotational force, tipping force, torquing force, etc.) without calculating the specific magnitude and/or direction of the force.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, so as to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients can require lower forces to expand the suture than older patients, as the suture has not yet fully formed.

In block 1006, a design for an orthodontic appliance configured to produce the force system is determined. The design can include the appliance geometry, material composition and/or material properties, and can be determined in various ways, such as using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA (Abaqus) software products from Dassault Systèmes of Waltham, MA.

Optionally, one or more designs can be selected for testing or force modeling. As noted above, a desired tooth movement, as well as a force system required or desired for eliciting the desired tooth movement, can be identified. Using the simulation environment, a candidate design can be analyzed or modeled for determination of an actual force system resulting from use of the candidate appliance. One or more modifications can optionally be made to a candidate appliance, and force modeling can be further analyzed as described, e.g., in order to iteratively determine an appliance design that produces the desired force system.

In block 1008, instructions for fabrication of the orthodontic appliance incorporating the design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Although the above steps show a method 1000 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 1000 may be performed with any suitable fabrication system or device, such as the embodiments described herein. Some of the steps may be optional, e.g., the process of block 1004 can be omitted, such that the orthodontic appliance is designed based on the desired tooth movements and/or determined tooth movement path, rather than based on a force system. Moreover, the order of the steps can be varied as desired.

FIG. 11 illustrates a method 1100 for digitally planning an orthodontic treatment and/or design or fabrication of an appliance, in accordance with embodiments. The method 1100 can be applied to any of the treatment procedures described herein and can be performed by any suitable data processing system.

In block 1102, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 1104, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 1106, at least one orthodontic appliance is fabricated based on the generated treatment stages. For example, a set of appliances can be fabricated, each shaped according to a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 11, design and/or fabrication of an orthodontic appliance, and perhaps a particular orthodontic treatment, may include use of a representation of the patient's teeth (e.g., including receiving a digital representation of the patient's teeth (block 1102)), followed by design and/or fabrication of an orthodontic appliance based on a representation of the patient's teeth in the arrangement represented by the received representation.

As noted herein, the techniques described herein can be used in combination with the direct fabrication of dental appliances, such as aligners and/or a series of aligners with tooth-receiving cavities configured to move a person's teeth from an initial arrangement toward a target arrangement in accordance with a treatment plan. Aligners can include mandibular repositioning elements, such as those described in U.S. Pat. No. 10,912,629, entitled “Dental Appliances with Repositioning Jaw Elements,” filed Nov. 30, 2015; U.S. Pat. No. 10,537,406, entitled “Dental Appliances with Repositioning Jaw Elements,” filed Sep. 19, 2014; and U.S. Pat. No. 9,844,424, entitled “Dental Appliances with Repositioning Jaw Elements,” filed Feb. 21, 2014; all of which are incorporated by reference herein in their entirety.

The techniques used herein can also be used in combination with attachment placement devices, e.g., appliances used to position prefabricated attachments on a person's teeth in accordance with one or more aspects of a treatment plan. Examples of attachment placement devices (also known as “attachment placement templates” or “attachment fabrication templates”) can be found at least in: U.S. application Ser. No. 17/249,218, entitled “Flexible 3D Printed Orthodontic Device,” filed Feb. 24, 2021; U.S. application Ser. No. 16/366,686, entitled “Dental Attachment Placement Structure,” filed Mar. 27, 2019; U.S. application Ser. No. 15/674,662, entitled “Devices and Systems for Creation of Attachments,” filed Aug. 11, 2017; U.S. Pat. No. 11,103,330, entitled “Dental Attachment Placement Structure,” filed Jun. 14, 2017; U.S. application Ser. No. 14/963,527, entitled “Dental Attachment Placement Structure,” filed Dec. 9, 2015; U.S. application Ser. No. 14/939,246, entitled “Dental Attachment Placement Structure,” filed Nov. 12, 2015; U.S. application Ser. No. 14/939,252, entitled “Dental Attachment Formation Structures,” filed Nov. 12, 2015; and U.S. Pat. No. 9,700,385, entitled “Attachment Structure,” filed Aug. 22, 2014; all of which are incorporated by reference herein in their entirety.

The techniques described herein can be used in combination with incremental palatal expanders and/or a series of incremental palatal expanders used to expand a person's palate from an initial position toward a target position in accordance with one or more aspects of a treatment plan. Examples of incremental palatal expanders can be found at least in: U.S. application Ser. No. 16/380,801, entitled “Releasable Palatal Expanders,” filed Apr. 10, 2019; U.S. application Ser. No. 16/022,552, entitled “Devices, Systems, and Methods for Dental Arch Expansion,” filed Jun. 28, 2018; U.S. Pat. No. 11,045,283, entitled “Palatal Expander with Skeletal Anchorage Devices,” filed Jun. 8, 2018; U.S. application Ser. No. 15/831,159, entitled “Palatal Expanders and Methods of Expanding a Palate,” filed Dec. 4, 2017; U.S. Pat. No. 10,993,783, entitled “Methods and Apparatuses for Customizing a Rapid Palatal Expander,” filed Dec. 4, 2017; and U.S. Pat. No. 7,192,273, entitled “System and Method for Palatal Expansion,” filed Aug. 7, 2003; all of which are incorporated by reference herein in their entirety.

### EXAMPLES

The following examples are included to further describe some aspects of the present technology, and should not be used to limit the scope of the technology.

Example 1. A computer-implemented method for determining camera pose for a patient image, the computer-implemented method comprising, by one or more processors:
receiving a two-dimensional (2D) image comprising a depiction of teeth of at least one jaw of a patient, wherein the 2D image is obtained using an imaging device;
identifying a set of tooth landmarks representing geometries and locations of the teeth in the 2D image, wherein the set of tooth landmarks are identified by inputting the 2D image into a first machine learning model, and wherein the first machine learning model is trained on image data and first tooth landmark data corresponding to the image data; and
determining a camera pose representing an estimated spatial relationship between the imaging device and the at least one jaw, wherein the camera pose is determined by inputting the identified set of tooth landmarks into a second machine learning model, and wherein the second machine learning model is trained on second tooth landmark data and camera pose data corresponding to the second tooth landmark data.

Example 2. The computer-implemented method of Example 1, wherein the determined camera pose comprises a position and orientation of the imaging device with respect to the at least one jaw.

Example 3. The computer-implemented method of Example 1 or 2, further comprising outputting, via a display, an indication of the determined camera pose to a user.

Example 4. The computer-implemented method of any one of Examples 1 to 3, further comprising comparing the determined camera pose to a target camera pose.

Example 5. The computer-implemented method of Example 4, further comprising outputting, via a display, instructions for adjusting the imaging device from the determined camera pose toward the target camera pose.

Example 6. The computer-implemented method of Example 5, further comprising outputting, via the display, instructions for obtaining an updated 2D image of the teeth with the imaging device after the imaging device is adjusted toward the target camera pose.

Example 7. The computer-implemented method of Example 6, further comprising:
receiving the updated 2D image, and
determining progress of the teeth with respect to a dental treatment plan, based on the updated 2D image.

Example 8. The computer-implemented method of Example 6 or 7, further comprising:
receiving the updated 2D image, and
detecting a disease or condition of the teeth or a change in the patient, based on the updated 2D image.

Example 9. The computer-implemented method of any one of Examples 1 to 8, wherein the image data comprises a plurality of training images of teeth, and wherein the first tooth landmark data comprises a corresponding set of training tooth landmarks for each training image of the plurality of training images.

Example 10. The computer-implemented method of Example 9, wherein the corresponding set of training tooth landmarks for each training image is generated by:
accessing the training image,
accessing a 3D model of teeth corresponding to the teeth of the training image,
registering the 3D model to the teeth of the training image, and
determining a set of training tooth landmarks in the training image based on the registration.

Example 11. The computer-implemented method of any one of Examples 1 to 10, wherein the set of tooth landmarks comprises a tooth segmentation mask.

Example 12. The computer-implemented method of Example 11, wherein the tooth segmentation mask includes a plurality of tooth masks and a tooth identifier for each tooth mask.

Example 13. The computer-implemented method of any one of Examples 1 to 12, wherein the set of tooth landmarks comprises one or more of crown centers, central incisors, a jaw center, or a dental midline.

Example 14. The computer-implemented method of any one of Examples 1 to 13, wherein the second tooth landmark data and the camera pose data are generated from 3D models of teeth.

Example 15. The computer-implemented method of any one of Examples 1 to 14, wherein the second tooth landmark data and the camera pose data are generated from training images of teeth.

Example 16. The computer-implemented method of any one of Examples 1 to 15, wherein the first tooth landmark data and the second tooth landmark data are the same.

Example 17. The computer-implemented method of any one of Examples 1 to 16, wherein at least one of the first machine learning model or the second machine learning model comprises a convolutional neural network.

Example 18. The computer-implemented method of any one of Examples 1 to 17, wherein the first machine learning model comprises a tooth segmentation model.

Example 19. The computer-implemented method of Example 18, wherein the tooth segmentation model comprises a semantic segmentation model, an object instance segmentation model, or a combination thereof.

Example 20. The computer-implemented method of any one of Examples 1 to 19, wherein the second machine learning model comprises a camera pose estimation model.

Example 21. The computer-implemented method of any one of Examples 1 to 20, further comprising receiving motion data associated with the imaging device, wherein the camera pose is determined based on the motion data.

Example 22. The computer-implemented method of any one of Examples 1 to 21, wherein the at least one jaw is a single jaw of the patient.

Example 23. The computer-implemented method of any one of Examples 1 to 22, wherein the at least one jaw includes an upper jaw and a lower jaw of the patient, and wherein the computer-implemented method further comprising determining a jaw pose representing an estimated spatial relationship between the upper jaw and the lower jaw.

Example 24. The computer-implemented method of Example 23, wherein the camera pose comprises a first camera pose representing an estimated spatial relationship between the imaging device and the upper jaw, and a second camera pose representing an estimated spatial relationship between the imaging device and the lower jaw, and wherein the jaw pose is determined based on the first camera pose and the second camera pose.

Example 25. The computer-implemented method of Example 23 or 24, further comprising outputting, via a display, an indication of the determined jaw pose to a user.

Example 26. The computer-implemented method of any one of Examples 23 to 25, further comprising outputting, via a display, instructions for adjusting the upper jaw and the lower jaw from the determined jaw pose toward a target jaw pose.

Example 27. The computer-implemented method of any one of Examples 1 to 26, wherein the camera pose is determined based on one or more intrinsic parameters of the imaging device.

Example 28. The computer-implemented method of Example 27, wherein the one or more intrinsic parameters comprise one or more of field of view, focal length, aperture, optical axis, center of projection, or principal point of the imaging device.

Example 29. The computer-implemented method of Example 27 or 28, wherein the one or more intrinsic parameters are input into the second machine learning model.

Example 30. The computer-implemented method of any one of Examples 27 to 29, wherein the one or more intrinsic parameters are used to adjust an output of the second machine learning model.

Example 31. The computer-implemented method of any one of Examples 1 to 30, wherein the 2D image comprises a photograph or a frame of a video.

Example 32. The computer-implemented method of any one of Examples 1 to 31, wherein the imaging device is remote from the one or more processors.

Example 33. The computer-implemented method of any one of Examples 1 to 32, wherein the imaging device comprises a camera that is part of or is operably coupled to a mobile device.

Example 34. The computer-implemented method of any one of Examples 1 to 33, wherein the one or more processors are part of a mobile device.

Example 35. A system for determining camera pose for a patient image, the system comprising:
one or more processors; and
a memory operably coupled to the one or more processors and storing instructions that, when executed by the one or more processors, cause the system to perform operations comprising:
   receiving a two-dimensional (2D) image comprising a depiction of teeth of at least one jaw of a patient, wherein the 2D image is obtained using an imaging device;
   identifying a set of tooth landmarks representing geometries and locations of the teeth in the 2D image, wherein the set of tooth landmarks are identified by inputting the 2D image into a first machine learning model, and wherein the first machine learning model is trained on image data and first tooth landmark data corresponding to the image data; and
   determining a camera pose representing an estimated spatial relationship between the imaging device and the at least one jaw, wherein the camera pose is determined by inputting the identified set of tooth landmarks into a second machine learning model, and wherein the second machine learning model is trained on second tooth landmark data and camera pose data corresponding to the second tooth landmark data.

Example 36. The system of Example 35, wherein the determined camera pose comprises a position and orientation of the imaging device with respect to the at least one jaw.

Example 37. The system of Example 35 or 36, wherein the operations further comprise outputting, via a display, an indication of the determined camera pose to a user.

Example 38. The system of any one of Examples 35 to 37, wherein the operations further comprise comparing the determined camera pose to a target camera pose.

Example 39. The system of Example 38, wherein the operations further comprise outputting, via a display, instructions for adjusting the imaging device from the determined camera pose toward the target camera pose.

Example 40. The system of Example 39, wherein the operations further comprise outputting, via the display, instructions for obtaining an updated 2D image of the teeth with the imaging device after the imaging device is adjusted toward the target camera pose.

Example 41. The system of Example 40, wherein the operations further comprise:
receiving the updated 2D image, and
determining progress of the teeth with respect to a dental treatment plan, based on the updated 2D image.

Example 42. The system of Example 40 or 41, wherein the operations further comprise:
receiving the updated 2D image, and
detecting a disease or condition of the teeth or a change in the patient, based on the updated 2D image.

Example 43. The system of any one of Examples 35 to 42, wherein the image data comprises a plurality of training images of teeth, and wherein the first tooth landmark data comprises a corresponding set of training tooth landmarks for each training image of the plurality of training images.

Example 44. The system of Example 43, wherein the corresponding set of training tooth landmarks for each training image is generated by:
accessing the training image,
accessing a 3D model of teeth corresponding to the teeth of the training image,
registering the 3D model to the teeth of the training image, and
determining a set of training tooth landmarks in the training image based on the registration.

Example 45. The system of Example 44, wherein the set of tooth landmarks comprises a tooth segmentation mask.

Example 46. The system of Example 45, wherein the tooth segmentation mask includes a plurality of tooth masks and a tooth identifier for each tooth mask.

Example 47. The system of any one of Examples 35 to 46, wherein the set of tooth landmarks comprises one or more of crown centers, central incisors, a jaw center, or a dental midline.

Example 48. The system of any one of Examples 35 to 47, wherein the second tooth landmark data and the camera pose data are generated from 3D models of teeth.

Example 49. The system of any one of Examples 35 to 48, wherein the second tooth landmark data and the camera pose data are generated from training images of teeth.

Example 50. The system of any one of Examples 35 to 49, wherein the first tooth landmark data and the second tooth landmark data are the same.

Example 51. The system of any one of Examples 35 to 50, wherein at least one of the first machine learning model or the second machine learning model comprises a convolutional neural network.

Example 52. The system of any one of Examples 35 to 51, wherein the first machine learning model comprises a tooth segmentation model.

Example 53. The system of Example 52, wherein the tooth segmentation model comprises a semantic segmentation model, an object instance segmentation model, or a combination thereof.

Example 54. The system of any one of Examples 35 to 53, wherein the second machine learning model comprises a camera pose estimation model.

Example 55. The system of any one of Examples 35 to 54, wherein the operations further comprise receiving motion data associated with the imaging device, wherein the camera pose is determined based on the motion data.

Example 56. The system of any one of Examples 35 to 55, wherein the at least one jaw is a single jaw of the patient.

Example 57. The system of any one of Examples 35 to 56, wherein the at least one jaw includes an upper jaw and a lower jaw of the patient, and wherein the operations further comprise determining a jaw pose representing an estimated spatial relationship between the upper jaw and the lower jaw.

Example 58. The system of Example 57, wherein the camera pose comprises a first camera pose representing an estimated spatial relationship between the imaging device and the upper jaw, and a second camera pose representing an estimated spatial relationship between the imaging device and the lower jaw, and wherein the jaw pose is determined based on the first camera pose and the second camera pose.

Example 59. The system of Example 57 or 58, wherein the operations further comprise outputting, via a display, an indication of the determined jaw pose to a user.

Example 60. The system of any one of Examples 57 to 59, wherein the operations further comprise outputting, via a display, instructions for adjusting the upper jaw and the lower jaw from the determined jaw pose toward a target jaw pose.

Example 61. The system of any one of Examples 35 to 60, wherein the camera pose is determined based on one or more intrinsic parameters of the imaging device.

Example 62. The system of Example 61, wherein the one or more intrinsic parameters comprise one or more of field of view, focal length, aperture, optical axis, center of projection, or principal point of the imaging device.

Example 63. The system of Example 61 or 62, wherein the one or more intrinsic parameters are input into the second machine learning model.

Example 64. The system of any one of Examples 61 to 63, wherein the one or more intrinsic parameters are used to adjust an output of the second machine learning model.

Example 65. The system of any one of Examples 35 to 64, wherein the 2D image comprises a photograph or a frame of a video.

Example 66. The system of any one of Examples 35 to 65, wherein the imaging device is remote from the one or more processors.

Example 67. The system of any one of Examples 35 to 66, wherein the imaging device comprises a camera that is part of or is operably coupled to a mobile device.

Example 68. The system of any one of Examples 35 to 67, wherein the one or more processors are part of a mobile device.

Example 69. A computer-implemented method for determining camera pose for a patient image, the computer-implemented method comprising, by one or more processors:
receiving a series of two-dimensional (2D) images comprising a depiction of teeth of at least one jaw of a patient, wherein the series of 2D images is obtained using an imaging device;
determining whether a previous camera pose representing an estimated spatial relationship between the imaging device and the at least one jaw at a first time should be updated; and
in response to a determination that the previous camera pose should be updated:
   selecting a 2D image of the series of 2D images,
   accessing a three-dimensional (3D) model of the patient's teeth,
   registering the 3D model to the selected 2D image, and
   determining, based on the registration, an updated camera pose representing an estimated spatial relationship between the imaging device and the at least one jaw at a second time after the first time.

Example 70. The computer-implemented method of Example 69, wherein the updated camera pose comprises a position and orientation of the imaging device with respect to the at least one jaw.

Example 71. The computer-implemented method of Example 69 or 70, further comprising outputting, via a display, an indication of the updated camera pose to a user.

Example 72. The computer-implemented method of Example 71, further comprising comparing the updated camera pose to a target camera pose.

Example 73. The computer-implemented method of Example 72, further comprising outputting, via a display, instructions for adjusting the imaging device from the updated camera pose toward the target camera pose.

Example 74. The computer-implemented method of Example 73, further comprising outputting, via the display, instructions for obtaining an updated 2D image of the teeth with the imaging device after the imaging device is adjusted toward the target camera pose.

Example 75. The computer-implemented method of Example 74, further comprising:
receiving the updated 2D image, and
determining progress of the teeth with respect to a dental treatment plan, based on the updated 2D image.

Example 76. The computer-implemented method of Example 74 or 75, further comprising:
receiving the updated 2D image, and
detecting a disease or condition of the teeth or a change in the patient, based on the updated 2D image.

Example 77. The computer-implemented method of any one of Examples 69 to 76, wherein the registration is based on the previous camera pose.

Example 78. The computer-implemented method of any one of Examples 69 to 77, further comprising generating a tooth segmentation mask for the 2D image, wherein the registration is based on the tooth segmentation mask.

Example 79. The computer-implemented method of any one of Examples 69 to 78, wherein determining whether the previous camera pose should be updated comprises determining whether a predetermined time interval has elapsed.

Example 80. The computer-implemented method of any one of Examples 69 to 79, wherein determining whether the previous camera pose should be updated comprises determining an amount of movement of the imaging device exceeds a predetermined threshold.

Example 81. The computer-implemented method of Example 80, further comprising receiving motion data from a motion sensor coupled to the imaging device, wherein the amount of movement is determined based on the motion sensor.

Example 82. The computer-implemented method of any one of Examples 69 to 81, wherein determining whether the previous camera pose should be updated comprises:
accessing a set of registration parameters generated from registering the 3D model to a previously obtained 2D image,
projecting the 3D model onto a 2D image of the series of 2D images using the set of registration parameters, and
determining whether a deviation between the projected 3D model and the 2D image exceeds a predetermined threshold.

Example 83. The computer-implemented method of any one of Examples 69 to 82, wherein the at least one jaw is a single jaw of the patient.

Example 84. The computer-implemented method of any one of Examples 69 to 83, wherein the at least one jaw includes an upper jaw and a lower jaw of the patient, and wherein the computer-implemented method further comprising determining a jaw pose representing an estimated spatial relationship between the upper jaw and the lower jaw, based on the registration.

Example 85. The computer-implemented method of any one of Examples 69 to 84, wherein the 2D image comprises a photograph or a frame of a video.

Example 86. The computer-implemented method of any one of Examples 69 to 85, wherein the imaging device is remote from the one or more processors.

Example 87. The computer-implemented method of any one of Examples 69 to 86, wherein the imaging device comprises a camera that is part of or is operably coupled to a mobile device.

Example 88. A system for determining camera pose for a patient image, the system comprising:
one or more processors; and
a memory operably coupled to the one or more processors and storing instructions that, when executed by the one or more processors, cause the system to perform operations comprising:
   receiving a series of two-dimensional (2D) images comprising a depiction of teeth of at least one jaw of a patient, wherein the series of 2D images is obtained using an imaging device;
   determining whether a previous camera pose representing an estimated spatial relationship between the imaging device and the at least one jaw at a first time should be updated; and
   in response to a determination that the previous camera pose should be updated:
      selecting a 2D image of the series of 2D images,
      accessing a three-dimensional (3D) model of the patient's teeth,
      registering the 3D model to the selected 2D image, and
      determining, based on the registration, an updated camera pose representing an estimated spatial relationship between the imaging device and the at least one jaw at a second time after the first time.

Example 89. The system of Example 88, wherein the updated camera pose comprises a position and orientation of the imaging device with respect to the at least one jaw.

Example 90. The system of Example 88 or 89, wherein the operations further comprise outputting, via a display, an indication of the updated camera pose to a user.

Example 91. The system of Example 90, wherein the operations further comprise comparing the updated camera pose to a target camera pose.

Example 92. The system of Example 91, wherein the operations further comprise outputting, via a display, instructions for adjusting the imaging device from the updated camera pose toward the target camera pose.

Example 93. The system of Example 92, wherein the operations further comprise outputting, via the display, instructions for obtaining an updated 2D image of the teeth with the imaging device after the imaging device is adjusted toward the target camera pose.

Example 94. The system of Example 93, wherein the operations further comprise:
receiving the updated 2D image, and
determining progress of the teeth with respect to a dental treatment plan, based on the updated 2D image.

Example 95. The system of Example 93 or 94, wherein the operations further comprise:
receiving the updated 2D image, and
detecting a disease or condition of the teeth or a change in the patient, based on the updated 2D image.

Example 96. The system of any one of Examples 88 to 95, wherein the registration is based on the previous camera pose.

Example 97. The system of any one of Examples 88 to 96, wherein the operations further comprise generating a tooth segmentation mask for the 2D image, wherein the registration is based on the tooth segmentation mask.

Example 98. The system of any one of Examples 88 to 97, wherein determining whether the previous camera pose should be updated comprises determining whether a predetermined time interval has elapsed.

Example 99. The system of any one of Examples 88 to 98, wherein determining whether the previous camera pose should be updated comprises determining an amount of movement of the imaging device exceeds a predetermined threshold.

Example 100. The system of Example 99, wherein the operations further comprise receiving motion data from a motion sensor coupled to the imaging device, wherein the amount of movement is determined based on the motion sensor.

Example 101. The system of anyone of Examples 88 to 100, wherein determining whether the previous camera pose should be updated comprises:
accessing a set of registration parameters generated from registering the 3D model to a previously obtained 2D image,
projecting the 3D model onto a 2D image of the series of 2D images using the set of registration parameters, and
determining whether a deviation between the projected 3D model and the 2D image exceeds a predetermined threshold.

Example 102. The system of any one of Examples 88 to 101, wherein the at least one jaw is a single jaw of the patient.

Example 103. The system of any one of Examples 88 to 102, wherein the at least one jaw includes an upper jaw and a lower jaw of the patient, and wherein the system further comprising determining a jaw pose representing an estimated spatial relationship between the upper jaw and the lower jaw, based on the registration.

Example 104. The system of any one of Examples 88 to 103, wherein the 2D image comprises a photograph or a frame of a video.

Example 105. The system of any one of Examples 88 to 104, wherein the imaging device is remote from the one or more processors.

Example 106. The system of any one of Examples 88 to 105, wherein the imaging device comprises a camera that is part of or is operably coupled to a mobile device.

Example 107. A computer-implemented method for determining camera pose for a patient image, the computer-implemented method comprising, by one or more processors:
receiving a two-dimensional (2D) image comprising a depiction of teeth of at least one jaw of a patient, wherein the 2D image is obtained using an imaging device; and
determining a camera pose representing an estimated spatial relationship between the imaging device and the at least one jaw, wherein the camera pose is determined by inputting the 2D image into a machine learning model, and wherein the machine learning model is trained on image data and corresponding camera pose data.

Example 108. The computer-implemented method of Example 107, wherein the determined camera pose comprises a position and orientation of the imaging device with respect to the at least one jaw.

Example 109. The computer-implemented method of Example 107 or 108, further comprising outputting an indication of the determined camera pose to a user via a display.

Example 110. The computer-implemented method of any one of Examples 107 to 109, further comprising comparing the determined camera pose to a target camera pose.

Example 111. The computer-implemented method of Example 110, further comprising outputting, via a display, instructions for adjusting the imaging device from the camera pose to the target camera pose.

Example 112. The computer-implemented method of Example 111, further comprising outputting, via the display, instructions for obtaining an updated 2D image of the teeth with the imaging device after the imaging device is adjusted toward the target camera pose.

Example 113. The computer-implemented method of Example 112, further comprising:
receiving the updated 2D image, and
determining progress of the teeth with respect to a dental treatment plan, based on the updated 2D image.

Example 114. The computer-implemented method of Example 112 or 113, further comprising:
receiving the updated 2D image, and
detecting a disease or condition of the teeth or a change in the patient, based on the updated 2D image.

Example 115. The computer-implemented method of any one of Examples 107 to 114, wherein image data comprises a plurality of training images of teeth, and wherein the camera pose data comprises a corresponding training camera pose for each training image.

Example 116. The computer-implemented method of Example 115, wherein the corresponding training camera pose for each training image is determined by:
accessing the training image,
accessing a 3D model of teeth corresponding to the teeth of the training image,
registering the 3D model to the training image, and
determining the training camera pose based on the registration.

Example 117. The computer-implemented method of any one of Examples 107 to 116, wherein the 2D image comprises a photograph or a frame of a video.

Example 118. The computer-implemented method of any one of Examples 107 to 117, wherein the imaging device is remote from the one or more processors.

Example 119. The computer-implemented method of any one of Examples 107 to 118, wherein the imaging device comprises a camera that is part of or is operably coupled to a mobile device.

Example 120. A system for determining camera pose for a patient image, the system comprising:
one or more processors; and
a memory operably coupled to the one or more processors and storing instructions that, when executed by the one or more processors, cause the system to perform operations comprising:
   receiving a two-dimensional (2D) image comprising a depiction of teeth of at least one jaw of a patient, wherein the 2D image is obtained using an imaging device; and
   determining a camera pose representing an estimated spatial relationship between the imaging device and the at least one jaw, wherein the camera pose is determined by inputting the 2D image into a machine learning model, and wherein the machine learning model is trained on image data and corresponding camera pose data.

Example 121. The system of Example 120, wherein the determined camera pose comprises a position and orientation of the imaging device with respect to the at least one jaw.

Example 122. The system of Example 120 or 121, wherein the operations further comprise outputting an indication of the determined camera pose to a user via a display.

Example 123. The system of any one of Examples 120 to 122, wherein the operations further comprise comparing the determined camera pose to a target camera pose.

Example 124. The system of Example 123, wherein the operations further comprise outputting, via a display, instructions for adjusting the imaging device from the camera pose to the target camera pose.

Example 125. The system of Example 124, wherein the operations further comprise outputting, via the display, instructions for obtaining an updated 2D image of the teeth with the imaging device after the imaging device is adjusted toward the target camera pose.

Example 126. The system of Example 125, wherein the operations further comprise:
receiving the updated 2D image, and
determining progress of the teeth with respect to a dental treatment plan, based on the updated 2D image.

Example 127. The system of Example 125 or 126, wherein the operations further comprise:
receiving the updated 2D image, and
detecting a disease or condition of the teeth or a change in the patient, based on the updated 2D image.

Example 128. The system of any one of Examples 120 to 127, wherein image data comprises a plurality of training images of teeth, and wherein the camera pose data comprises a corresponding training camera pose for each training image.

Example 129. The system of Example 128, wherein the corresponding training camera pose for each training image is determined by:
accessing the training image,
accessing a 3D model of teeth corresponding to the teeth of the training image,
registering the 3D model to the training image, and
determining the training camera pose based on the registration.

Example 130. The system of any one of Examples 120 to 129, wherein the 2D image comprises a photograph or a frame of a video.

Example 131. The system of any one of Examples 120 to 130, wherein the imaging device is remote from the one or more processors.

Example 132. The system of any one of Examples 120 to 131, wherein the imaging device comprises a camera that is part of or is operably coupled to a mobile device.

Example 133. A computer-implemented method for training a machine learning model for determining camera pose, the computer-implemented method comprising, by one or more processors:
receiving a plurality of two-dimensional (2D) images, each 2D image comprising a depiction of teeth of at least one jaw of a patient obtained using an imaging device;
identifying a set of tooth landmarks for each 2D image, wherein the set of tooth landmarks represents geometries and locations of the teeth in the respective 2D image;
determining a corresponding camera pose for each set of tooth landmarks, wherein the corresponding camera pose is determined based on a registration of a 3D model of the teeth of the respective patient to the respective 2D image, and wherein the corresponding camera pose represents an estimated spatial relationship between the respective imaging device and the at least one jaw of the respective patient; and
training a machine learning model based on the plurality of 2D images and the corresponding camera poses.

Example 134. A computer-implemented method for evaluating an acceptability of a patient image, the computer-implemented method comprising, by one or more processors:
(a) receiving a two-dimensional (2D) image comprising a depiction of a patient's teeth;
(b) evaluating whether the 2D image satisfies an image acceptability threshold;
(c) in response to a determination that the 2D image does not satisfy the image acceptability threshold, decreasing the image acceptability threshold after a predetermined time has elapsed, after a predetermined number of evaluations have been performed, or a combination thereof; and
repeating processes (a)-(c) until a 2D image that satisfies the image acceptability threshold is received.

Example 135. The computer-implemented method of Example 134, wherein the evaluating comprises:
calculating an image acceptability parameter for the 2D image, and
comparing the image acceptability parameter to the image acceptability threshold.

Example 136. The computer-implemented method of Example 134 or 135, wherein the image acceptability threshold has an initial value based on one or more of the patient's medical data, demographic data, environmental data, or anatomical structures of interest.

Example 137. The computer-implemented method of any one of Examples 134 to 136, wherein the image acceptability threshold is decreased according to an exponential falloff function, a modified exponential falloff function, a percentile falloff function, or a sigmoidal falloff function.

Example 138. The computer-implemented method of any one of Examples 134 to 137, further comprising monitoring progress of the teeth with respect to a dental treatment plan, based on the 2D image.

Example 139. The computer-implemented method of any one of Examples 134 to 138, further comprising detecting a disease or condition of the teeth, based on the 2D image.

Example 140. The computer-implemented method of any one of Examples 134 to 139, wherein the 2D image comprises a photograph or a frame of a video.

Example 141. The computer-implemented method of any one of Examples 134 to 140, wherein the 2D image is received from an imaging device that is remote from the one or more processors.

Example 142. The computer-implemented method of any one of Examples 134 to 141, wherein the 2D image is received from an imaging device comprising a camera that is part of or is operably coupled to a mobile device.

Example 143. The computer-implemented method of any one of Examples 134 to 142, wherein the one or more processors are part of a mobile device.

Example 144. A system for evaluating an acceptability of a patient image, the system comprising:
one or more processors; and
a memory operably coupled to the one or more processors and storing instructions that, when executed by the one or more processors, cause the system to perform operations comprising:
   (a) receiving a two-dimensional (2D) image comprising a depiction of a patient's teeth;
   (b) evaluating whether the 2D image satisfies an image acceptability threshold;
   (c) in response to a determination that the 2D image does not satisfy the image acceptability threshold, decreasing the image acceptability threshold after a predetermined time has elapsed, after a predetermined number of evaluations have been performed, or a combination thereof; and repeating processes (a)-(c) until a 2D image that satisfies the image acceptability threshold is received.

Example 145. The system of Example 144, wherein the evaluating comprises: calculating an image acceptability parameter for the 2D image, and comparing the image acceptability parameter to the image acceptability threshold.

Example 146. The system of Example 144 or 145, wherein the image acceptability threshold has an initial value based on one or more of the patient's medical data, demographic data, environmental data, or anatomical structures of interest.

Example 147. The system of any one of Examples 144 to 146, wherein the image acceptability threshold is decreased according to an exponential falloff function, a modified exponential falloff function, a percentile falloff function, or a sigmoidal falloff function.

Example 148. The system of any one of Examples 144 to 147, wherein the operations further comprise determining progress of the teeth with respect to a dental treatment plan, based on the 2D image.

Example 149. The system of any one of Examples 144 to 148, wherein the operations further comprise detecting a disease or condition of the teeth or a change in the patient, based on the 2D image.

Example 150. The system of any one of Examples 144 to 149, wherein the 2D image comprises a photograph or a frame of a video.

Example 151. The system of any one of Examples 144 to 150, wherein the 2D image is received from an imaging device that is remote from the one or more processors.

Example 152. The system of any one of Examples 144 to 151, wherein the 2D image is received from an imaging device comprising a camera that is part of or is operably coupled to a mobile device.

Example 153. The system of any one of Examples 144 to 152, wherein the one or more processors are part of a mobile device.

### CONCLUSION

Although many of the embodiments are described above with respect to systems, devices, and methods for determining a camera pose for images of a patient's teeth, the technology is applicable to other applications and/or other approaches, such as determining camera pose for images of other anatomical locations. Moreover, other embodiments in addition to those described herein are within the scope of the technology. Additionally, several other embodiments of the technology can have different configurations, components, or procedures than those described herein. A person of ordinary skill in the art, therefore, will accordingly understand that the technology can have other embodiments with additional elements, or the technology can have other embodiments without several of the features shown and described above with reference to FIGS. 1A-11.

The various processes described herein can be partially or fully implemented using program code including instructions executable by one or more processors of a computing system for implementing specific logical functions or steps in the process. The program code can be stored on any type of computer-readable medium, such as a storage device including a disk or hard drive. Computer-readable media containing code, or portions of code, can include any appropriate media known in the art, such as non-transitory computer-readable storage media. Computer-readable media can include volatile and non-volatile, removable and non-removable media implemented in any method or technology for storage and/or transmission of information, including, but not limited to, random-access memory (RAM), read-only memory (ROM), electrically erasable programmable read-only memory (EEPROM), flash memory, or other memory technology; compact disc read-only memory (CD-ROM), digital video disc (DVD), or other optical storage; magnetic cassettes, magnetic tape, magnetic disk storage, or other magnetic storage devices; solid state drives (SSD) or other solid state storage devices; or any other medium which can be used to store the desired information and which can be accessed by a system device.

The descriptions of embodiments of the technology are not intended to be exhaustive or to limit the technology to the precise form disclosed above. Where the context permits, singular or plural terms may also include the plural or singular term, respectively. Although specific embodiments of, and examples for, the technology are described above for illustrative purposes, various equivalent modifications are possible within the scope of the technology, as those skilled in the relevant art will recognize. For example, while steps are presented in a given order, alternative embodiments may perform steps in a different order. The various embodiments described herein may also be combined to provide further embodiments.

As used herein, the terms “generally,” “substantially,” “about,” and similar terms are used as terms of approximation and not as terms of degree, and are intended to account for the inherent variations in measured or calculated values that would be recognized by those of ordinary skill in the art.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. As used herein, the phrase “and/or” as in “A and/or B” refers to A alone, B alone, and A and B. Additionally, the term “comprising” is used throughout to mean including at least the recited feature(s) such that any greater number of the same feature and/or additional types of other features are not precluded.

To the extent any materials incorporated herein by reference conflict with the present disclosure, the present disclosure controls.

It will also be appreciated that specific embodiments have been described herein for purposes of illustration, but that various modifications may be made without deviating from the technology. Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. A system for determining camera pose for a patient image, the system comprising:
one or more processors; and
a memory operably coupled to the one or more processors and storing instructions that, when executed by the one or more processors, cause the system to perform operations comprising:
receiving a two-dimensional (2D) image comprising a depiction of teeth of at least one jaw of a patient, wherein the 2D image is obtained using an imaging device;
identifying a set of tooth landmarks representing geometries and locations of the teeth in the 2D image, wherein the set of tooth landmarks are identified by inputting the 2D image into a first machine learning model, and wherein the first machine learning model is trained on image data and first tooth landmark data corresponding to the image data; and
determining a camera pose representing an estimated spatial relationship between the imaging device and the at least one jaw, wherein the camera pose is determined by inputting the identified set of tooth landmarks into a second machine learning model, and wherein the second machine learning model is trained on second tooth landmark data and camera pose data corresponding to the second tooth landmark data.

2. The system of claim 1, wherein the determined camera pose comprises a position and orientation of the imaging device with respect to the at least one jaw.

3. The system of claim 1, wherein the operations further comprise outputting, via a display, an indication of the determined camera pose to a user.

4. The system of claim 1, wherein the operations further comprise comparing the determined camera pose to a target camera pose.

5. The system of claim 4, wherein the operations further comprise outputting, via a display, instructions for adjusting the imaging device from the determined camera pose toward the target camera pose.

6. The system of claim 5, wherein the operations further comprise:
outputting, via the display, instructions for obtaining an updated 2D image of the teeth with the imaging device after the imaging device is adjusted toward the target camera pose.

7. The system of claim 6, wherein the operations further comprise:
receiving the updated 2D image, and
determining progress of the teeth with respect to a dental treatment plan, based on the updated 2D image.

8. The system of claim 6, wherein the operations further comprise:
receiving the updated 2D image, and
detecting a disease or condition of the teeth or a change in the patient, based on the updated 2D image.

9. The system of claim 1, wherein at least one of the first machine learning model or the second machine learning model comprises a convolutional neural network.

10. The system of claim 1, wherein the first machine learning model comprises a tooth segmentation model.

11. The system of claim 1, wherein the second machine learning model comprises a camera pose estimation model.

12. The system of claim 1, wherein the at least one jaw includes an upper jaw and a lower jaw of the patient, and wherein the operations further comprise determining a jaw pose representing an estimated spatial relationship between the upper jaw and the lower jaw.

13. The system of claim 1, wherein the one or more processors are part of a mobile device.

14. A computer-implemented method for determining camera pose for a patient image, the computer-implemented method comprising, by one or more processors:
receiving a two-dimensional (2D) image comprising a depiction of teeth of at least one jaw of a patient, wherein the 2D image is obtained using an imaging device;
identifying a set of tooth landmarks representing geometries and locations of the teeth in the 2D image, wherein the set of tooth landmarks are identified by inputting the 2D image into a first machine learning model, and wherein the first machine learning model is trained on image data and first tooth landmark data corresponding to the image data; and
determining a camera pose representing an estimated spatial relationship between the imaging device and the at least one jaw, wherein the camera pose is determined by inputting the identified set of tooth landmarks into a second machine learning model, and wherein the second machine learning model is trained on second tooth landmark data and camera pose data corresponding to the second tooth landmark data.

15. The computer-implemented method of claim 14, further comprising outputting, via a display, an indication of the determined camera pose to a user.

16. The computer-implemented method of claim 14, further comprising comparing the determined camera pose to a target camera pose and outputting, via a display, instructions for adjusting the imaging device from the determined camera pose toward the target camera pose.

17. The computer-implemented method of claim 16, further comprising outputting, via the display, instructions for obtaining an updated 2D image of the teeth with the imaging device after the imaging device is adjusted toward the target camera pose.

18. The computer-implemented method of claim 17, further comprising:
receiving the updated 2D image, and
determining progress of the teeth with respect to a dental treatment plan, based on the updated 2D image.

19. The computer-implemented method of claim 17, further comprising:
receiving the updated 2D image, and
detecting a disease or condition of the teeth or a change in the patient, based on the updated 2D image.

20. A system for determining camera pose for a patient image, the system comprising:
one or more processors; and
a memory operably coupled to the one or more processors and storing instructions that, when executed by the one or more processors, cause the system to perform operations comprising:
receiving a series of two-dimensional (2D) images comprising a depiction of teeth of at least one jaw of a patient, wherein the series of 2D images is obtained using an imaging device;
determining whether a previous camera pose representing an estimated spatial relationship between the imaging device and the at least one jaw at a first time should be updated; and
in response to a determination that the previous camera pose should be updated:
selecting a 2D image of the series of 2D images,
accessing a three-dimensional (3D) model of the patient's teeth,
registering the 3D model to the selected 2D image, and
determining, based on the registration, an updated camera pose representing an estimated spatial relationship between the imaging device and the at least one jaw at a second time after the first time.
